(19) United States
(12) Patent Application Publication
(10) Pub. No.: US 2009/0291236 A1
(43) Pub. Date: Nov. 26, 2009

(54) METHOD FOR PRODUCING SHAPE-ANISOTROPIC METAL PARTICLES, COLORING COMPOSITION, PHOTOSENSITIVE TRANSFER MATERIAL, SUBSTRATE WITH A BLACK IMAGE, COLOR FILTER, AND LIQUID CRYSTAL DISPLAY ELEMENT

(75) Inventors: Misato Sasada, Minami-Ashigara-shi (JP); Kousaku Yoshimura, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku, Tokyo (JP)

(21) Appl. No.: 12/090,618

(22) PCT Filed: Oct. 18, 2006
(86) PCT No.: PCT/JP2006/320725

§ 371 Date: Apr. 17, 2008

(30) Foreign Application Priority Data
Oct. 19, 2005 (JP) 2005-305026

(51) Int. Cl. F21V 9/06; C09K 19/00

(52) U.S. Cl. 428/1.1; 252/586

(57) ABSTRACT

The present invention provides a method for producing shape-anisotropic metal particles having at least reducing a metal compound in the presence of a polymer dispersant which has a mercapto group within its molecule. The present invention further provides a coloring composition which is obtained by disposing the shape-anisotropic metal particles in a solvent having an SP value of 25.8 MPa^{1/2} or less, the shape-anisotropic metal particles being produced by a method.

### FIELD OF THE INVENTION

The present invention relates to a method for producing shape-anisotropic metal particles and to a coloring composition, photosensitive transfer material, substrate with a black image, color filter, and liquid crystal display element containing such shape-anisotropic metal particles.

### BACKGROUND OF THE INVENTION

Black material coloring compositions are widely used for light-blocking images, such as in printing inks, inkjet inks, etching resists, solder resists, partition walls of plasma-display panels (PDP), dielectric patterns, electrode (conductor circuit) patterns, wiring patterns of electronic components, conductive pastes, electrically conducting films, and black matrixes. These light-blocking images also include various other light-blocking images such as the black edge provided around the periphery of displays, such as liquid crystal displays, plasma displays, electroluminescence (EL) displays, cathode-ray tube (CRT) displays, and also so-called black matrixes (sometimes referred to below as “BM”), such as lattice or stripe shaped black portions between red, blue and green pixels, and dot shaped or line shaped black color patterns for light-blocking in thin-film transistors (TFT).

BMs are used in order to raise display contrast, and, in the case of liquid crystal displays of an active matrix driving method using a thin film transistor (TFT), in order to prevent image quality degradation by current leakage due to light, and therefore a high light-blocking ability thereof (an optical density OD of three or more) is required.

In addition, liquid crystal displays have recently come to be used for TVs. However, since TVs use color filters having low transmissivity and high color purity, there is a tendency to use higher-intensity backlights, and therefore high light-blocking ability is required for BMs in order to prevent a drop in contrast and to prevent transparency of the peripheral frame portion.

Furthermore, there is a fear that if a TV is placed for a long time in the room with incident sunlight, deterioration may occur of a TFT from such sunlight, and high light-blocking ability is required of BMs since (1) images give an impression of “tightness” with high OD, that is to say when the contrast is high, and (2) the whiteness of liquid crystals in outdoor daylight becomes less conspicuous.

Forming methods of BMs made from metal films, such as chromium formed into a light-blocking layer, include a method of forming a BM by, for example, producing a metal thin film by a vacuum deposition method or a sputtering method, and coating a photoresist on such a metal thin film. Light exposure and development using a photomask with the BM pattern may then be performed to the photoresist layer, the light-exposed metal thin film then etched, and finally the resist layer on the metal thin film separated therefrom (see, for example, the Non-Patent Document 1).

This method has the advantage that a high light-blocking effect may be obtained even if film thickness is small, since a metal thin film is used. However, a vacuum film formation process such as vacuum deposition method or sputtering method, an etching process and the like are needed, and this entails a high cost, and the environmental impact thereof also cannot be ignored. Moreover, since the BM uses a metal film, the reflectance thereof is also high, and so display contrast is low under strong outdoor daylight. In contrast, there is a technique which uses low reflection chromium films (consisting of a double-layer of a chromium metal layer and a chromium oxide layer, or the like), as the metal thin film. However, this leads to an undeniable increase in costs.

Moreover, there is also another BM forming method known which uses a photosensitive resin composition containing a light-blocking pigment such as, for example, carbon black. In such a method, after forming red (R) pixels, green (G) pixels, and blue (B) pixels on a transparent substrate, a self-alignment method of forming a BM is used in which a carbon black containing-photosensitive resin composition is coated on these pixels, and then the substrate is light-exposed over the entire surface thereof from the opposite side to the side on which the R, G and B pixels are formed (see, for example, the Patent Document 1).

In such a method, although the manufacturing cost becomes low as compared with the above method of etching a metal film, a thick film thickness is required in order to obtain sufficient light-blocking ability. As a result, an overlap of the BM and the R, G, and B pixels (level difference) arises, so that the flatness characteristics of the color filter deteriorate, unevenness in the cell gaps of the liquid crystal display element occurs, and this can lead to display defects, such as color unevenness.

There is a method proposed for producing a BM wherein: a photosensitive resist layer containing a hydrophilic resin is formed on a transparent substrate; light-exposure and development is performed through a photomask with a BM pattern to form a relief on the transparent substrate; the transparent substrate is placed in contact with an aqueous solution of a metal compound which works as an electroless plating catalyst so that the metal compound is placed within the relief; the relief is dried and subjected to heat treatment; and then the relief is contacted on the transparent substrate with an electroless plating liquid, so that a BM is produced with metal particles for light-blocking of a particle size of from 0.01 μm to 0.05 μm uniformly distributed within the relief (see, for example, Patent Document 2). Nickel, cobalt, iron, copper, and chromium are listed for the metal particles, but only nickel is shown as a specific example.

However, this method has many complicated treatment processes that use water, such as for the relief formation including light-exposing and development, the application of the electroless plating catalyst, the heat treatment, and the electroless plating. Therefore, it cannot be expected that this method will remarkably lead to low cost BM production.

Moreover, although there is an example in the Patent Document 3 of a coloring composition using a magnetic filler for producing a black color pattern, this example is for a thick film having a thickness of 10 microns or more, and the density of the filler per unit film thickness is low, and so there is no expectation that this method will lead to low cost production of light-blocking images with a high light-blocking performance in a thin film.

Although examples are described in the Patent Documents 4 and 5 of using nanowires formed from metal particles as electrically conductive material, since there is a lot of aggregation seen when such particles are washed and concentrated, the flatness characteristics of a color filter deteriorate, and this can lead to display defects, such as color unevenness. These materials therefore cannot be used as coloring materials for displays.

Moreover, there is an example of a method of producing a black color pattern using a coloring composition containing shape-anisotropic metal particles, using metal particles with an aspect ratio of two or above in the coloring composition (see, for example, Patent Document 4). However, when a black color filter is produced using such metal particles, display unevenness occurs and it is found that this is not adequate as a black matrix substrate.

Disruption of liquid crystal orientation is caused when a black matrix substrate surface is not smooth, which is said to be the cause of display unevenness. Display unevenness is a faint unevenness observed when a gray test signal is input into a liquid crystal display. The “streaky unevenness”, which is visible in the form of comparatively distinct streaks, are thought to occur due to: thickness unevenness generated when forming a photosensitive resin layer; unevenness generated at the time of formation of orientation control projections, such as light-exposure unevenness, unevenness of developing, or unevenness of heat treatment; and unevenness that occurs due to interaction between the orientation control projections and liquid crystals and the like when functioning as a liquid crystal display. However, the mechanisms by which such unevenness occurs are not yet certain.

Moreover, manufacturing methods of chain shaped anisotropic metal particles, formed by connecting together plural metal particles, are shown in the Patent Documents 5 and 6. In each of these patent publications, there is a manufacturing method for the metal particles for the purpose of the production of electrically conductive materials. It has been found that the chain shape-anisotropic metal particles described in the Patent Documents 5 and 6 have low dispersion stability when particles were washed and concentrated, and aggregates therefore often occur, damaging the flatness characteristics as a color filter when the chain shape-anisotropic metal particles described in the Patent Documents 5 and 6 are applied to optical materials for uses such as in color filters or liquid crystal displays. These methods therefore turn out to have no value in practice. Moreover, in a method described in Patent Document 6, particles that are connected in chains may only be obtained in a condition in which the concentration of the particle is extremely low, and thus such a method is not suitable for production. Furthermore, if the lengths of obtained particles are of a comparatively mono-variance, the absorption therefrom will be split into two distinct bands, and it can be assumed that the particles will exhibit a vivid color. However, while a wide absorption band, that is different from that obtained from single particles, may be obtained, it is difficult to obtain the desired color tone since the lengths of the particles are not equal by the method described in Patent Document 6. As described above, it is difficult to prepare a coloring composition with dispersion stability that enables adjusting the color tone by shape anisotropy and is of any value in practice as a display material.

Furthermore, although these metal particles are dispersed in highly polar solvents, such as from water to low alcohols, it is difficult to prepare such metal particles dispersed in organic solvents having low polarity without forming aggregations.

### Patent Document 1: Japanese Patent Application Laid-Open (JP-A) No. 62-9301

### Patent Document 2: Japanese Patent No. 3318353

### Patent Document 3: JP-A No. 2001-13678

### Patent Document 4: JP-A No. 2005-17322

### Patent Document 5: JP-A No. 2001-279304

### Patent Document 6: International Publication (WO) No. 2003/068674

Non-Patent Document 1: Pages 218 to 220 of “Color TFT Liquid Crystal Displays”, published by KYORITSU SHUPPAN Co., Ltd. (Apr. 10, 1997)

### DESCRIPTION OF THE INVENTION

### Problem(s) to be Solved by the Invention

The invention was made in consideration of the above circumstances. Namely, the invention provides a method for producing shape-anisotropic metal particles which enables the manufacture of shape-anisotropic metal particles with high dispersion stability.

Moreover, the invention provides a coloring composition with which a high color density may be obtained in a thin film, and in particular a coloring composition and a photosensitive transfer material which enable the production of light-blocking images of high light-blocking performance and excellent environmental characteristics at low cost. The invention also provides a light-blocking image-applied substrate, a color filter, and a liquid crystal display which are thin and have high light-blocking performance.

### Means for Solving the Problem

That is, the invention provides: (1) a method for producing shape-anisotropic metal particles comprising reducing a metal compound in the presence of a polymer dispersant which has a mercapto group within its molecule.

In a preferable embodiment (2), in the method (1), the shape-anisotropic metal particles are formed by connecting together a plurality of metal particles, and differences in the combination lengths of the plurality of metal particles cause differences in color tones of the connecting metal particles.

In a preferable embodiment (3), in the method of (1) or (2), the shape-anisotropic metal particles are formed from composite particles formed of a metal compound and a metal.

In a preferable embodiment (4), in the method of any one of (1) to (3), the shape-anisotropic metal particles have absorption maxima in two or more wavelength regions of the wavelength regions of ultraviolet light, visible light, and near-infrared light, and the absorption wavelength is changed by changing a combination length of the metal particles.

In a preferable embodiment (5), in the method of any one of (1) to (4), the polymer dispersant comprises at least two or more mercapto groups at a terminus/termini of its molecule chain.

Furthermore, the invention provides (6) a coloring composition containing shape-anisotropic metal particles obtained by any one of the methods (1) to (5) in a solvent having an SP value of 25.8 MPa^{1/2} or less.

In a preferable embodiment (7), the coloring composition (6) further comprises a pigment.

Furthermore, in a preferable embodiment (8), the pigment of the embodiment (7) comprises at least one pigment selected from the group consisting of carbon black, titanium black, and graphite.

The invention further provides (9) a photosensitive transfer material comprising at least a photosensitive light-blocking layer provided on a support, wherein the photosensitive light-blocking layer is formed with the coloring composition described in any one of (6) to (8).

The invention further provides (10) a light-blocking image-applied substrate, wherein the light-blocking image is formed using the coloring composition described in any one of (6) to (8).

The invention further provides (11) a light-blocking image-applied substrate, wherein the light-blocking image is formed using the photosensitive transfer material (9).

The invention further provides (12) a color filter formed using the coloring composition described in any one of (6) to (8).

The invention further provides (13) a liquid crystal display device formed using the coloring composition described in any one of (6) to (8).

### EFFECT OF THE INVENTION

The invention provides a method for producing shape-anisotropic metal particles which enables the manufacture of shape-anisotropic metal particles with high dispersion stability.

Moreover, the invention provides a coloring composition which enables to obtain a high color density with a thin film, and in particular enables low cost production of a coloring composition and of a photosensitive transfer material, which have light-blocking images of high light-blocking performance and are excellent in environmental characteristics. The invention also provides a substrate applied with light-blocking images of high light-blocking performance with a thin film, a color filter, and a liquid crystal display device.

### BEST MODE OF CARRYING OUT THE INVENTION

The method for producing shape-anisotropic metal particles of the invention includes the process of reducing a metal compound in the presence of a polymer dispersant which has a mercapto group within its molecule.

First, the shape-anisotropic metal particles which can be obtained by the manufacturing method of the invention will be explained below.

Shape-Anisotropic Metal Particles

The shape-anisotropic metal particles according to the invention are particles of plural metal particles connected together in a chain, and such particles are manufactured by reducing a metal compound in a raw material metal compound solution containing a polymer dispersant which has a mercapto group within its molecule. The size of single particles of such plural metal particles is preferably 2 nm to 100 nm. The combination length of the plural metal particles is preferably 5 nm to 1000 nm, and is more preferably 5 nm to 500 nm.

The color tone may be changed when the combination length of the plural metal particles changes. For example, when 2 to 4 particles are connected, the connected particles exhibit a red color, and when 5 to 8 particles are connected they exhibit a blue to green color.

The shape-anisotropic metal particles according to the invention have an absorption maxima in two or more wavelength regions in the wavelength regions of ultraviolet light, visible light, and near-infrared light, and the absorption wavelength may be changed by changing the combination length of the plural metal particles. Specifically, particles formed by connecting 4 to 6 particles have absorption maxima at about 400 nm and about 600 nm, while particles formed by connecting 6 to 8 particles have absorption maxima at about 400 nm and about 700 nm.

Metal Particles

The metal particles used in the invention are not particularly limited, and any metal particles may be used. Preferable examples of the metal particles of the invention include those containing, as a principal component, a metal selected from the group consisting of the fourth period, fifth period, and sixth period with reference to the long periodic table (IUPAC1991) of elements, and preferable examples thereof further include those containing, as a principal component, a metal selected from the group consisting of Group 2, Group 8, Group 9, Group 10, Group 11, Group 12, Group 13, and Group 14.

Preferable examples of the metal particles which can be used as a dispersed metal particles include at least one metal selected from the group consisting of copper, silver, gold, platinum, palladium, nickel, tin, cobalt, rhodium, iridium, iron, ruthenium, osmium, manganese, molybdenum, tungsten, niobium, tantalum, titanium, bismuth, antimony, lead, and alloys thereof. These metals are suitable from a standpoint of having a light absorption peak, due to surface plasmon resonance of the metal particles, within the applicable wavelength band of 300 nm to 800 nm. More preferable examples of the metal include at least one selected from the group consisting of copper, silver, gold, platinum, palladium, nickel, tin, cobalt, rhodium, iridium and alloys thereof, and further preferable examples thereof include at least one selected from the group consisting of copper, silver, gold, platinum, tin, and alloys thereof.

Moreover, composite particles formed of a metal compound and a metal may be used as the metal particles in the invention.

### Metal Compound

The “metal compound” herein refers to a compound formed of a metal as described above and element(s) other than the metal.

Examples of the compounds formed of the metal and other element(s) include metal oxides, metal sulfides, metal sulfates, metal carbonates, and the like. Among these, metal sulfides are particularly preferable from the standpoint of ease of color tone and particle formation. Examples of the metal compounds include copper (II) oxide, iron sulfide, silver sulfide, copper (II) sulfide, titanium black, and the like. Silver sulfide is particularly preferable from the standpoint of color tone and ease of carrying out particle formation, and the standpoint of stability.

Composite Particles

The “composite particle formed of a metal compound and a metal” herein refers to a particle in which a metal and a metal compound is combined to form a single particle. There are no particular limitations to the shape of the composite particle. Examples thereof include a particle in which the composition of the inside the particle differs from that of the surface of the particle, and a particle formed by uniting two different kinds of particles. Moreover, t each of the metal compound and the metal in the composite particle may include a single kind thereof or two or more kinds thereof. Specific examples of the composite particles formed of the metal compound and the metal include composite particles formed of silver and silver sulfide, composite particles formed of silver and tin, and composite particles formed of silver and copper (II) oxide.

In the manufacturing method of the metal particle-containing liquid of the invention, a raw material metal compound solution containing a polymer dispersant having a mercapto group within its molecule is firstly prepared.

There are no particular limitations to the metal compound as long as it can be dissolved in a solvent to be used. Examples of the metal compound include sulfides, acetates, nitrates, perchlorates, hydrochlorides and the like of one or more metal(s) selected from the group consisting of copper, silver, gold, platinum, palladium, nickel, tin, cobalt, rhodium, iridium, iron, ruthenium, osmium, manganese, molybdenum, tungsten, niobium, tantalum, titanium, bismuth, antimony, and lead. Among these, the acetates, the nitrates, and the sulfides are preferable.

Examples of the solvent include water and organic solvents.

There are no particular limitations to the organic solvents. Examples of the organic solvents include: ketones such as acetone; alcohols such as methoxypropanol, ethoxyethanol, or propanol; 1-acetoxy 1-methoxypropane; diethylamino ethanol; and ethylene glycol. A water-soluble solvent is preferably used when water washing and precipitation is used as a post treatment. Examples of the water-soluble solvents include acetone, methoxypropanol, ethoxyethanol, and diethylamino ethanol. Moreover, the solvent is not limited to a single solvent, and a mixture of plural solvents may be used.

An amine containing-compound can be preferably included in the above solvent(s). Examples of the amine containing-compounds include: alkanolamines, such as diethylamino ethanol, ethanolamine, propanolamine, triethanolamine, and dimethylaminopropanol; aliphatic amines, such as propylamine, butylamine, dipropylene amine, ethylene diamine, and triethylene pentamine; alicyclic amines, such as, piperidine, pyrrolidine, N-methylpyrrolidine, and morpholine; aromatic amines, such as aniline, N-methylaniline, toluidine, anisidine, and phenetidine; and aralkylamines, such as benzylamine, xylene diamine, and N-methylbenzylamine.

Preferable examples of the amine containing-compound include alkanolamines, with specific examples thereof being ethanolamine, propanolamine, and diethylamino ethanol, and more preferable examples thereof include ethanolamine.

It is preferable that a base is added to the liquid so as to keep the pH of the liquid at pH 8 or above when the amine containing-compound is not contained in the liquid.

Production Method of Shape-Anisotropic Metal Particles

The method for producing shape-anisotropic metal particles of the invention includes reducing a metal compound in the presence of a polymer dispersant which has a mercapto group within its molecule, as described above. The polymer dispersant will first be explained below.

Polymer Dispersant

The polymer dispersant has a structure where a mercapto group, which has a high affinity to a metal surface, is introduced into a polymer having a large molecular weight.

The polymer dispersant is thought to work for stabilizing generation of the metal colloid particles due to the reduction of a metal compound, and stabilizing the dispersed condition of the metal colloid particles in the solvent after the metal colloid particles are generated.

The number average molecular weight of the polymer dispersant is preferably from 600 to 500,000. When the number average molecular weight of the polymer dispersant is less than 600, the dispersion stability may be sometimes insufficient, and when the number average molecular weight of the polymer dispersant exceeds 500,000, viscosity thereof may be too high and handling thereof may be difficult. The number average molecular weight of the polymer dispersant is more preferably from 1000 to 300,000, and is further preferably from 3,000 to 100,000.

Preferable examples of the polymer dispersant used in the invention include the polymer compound represented by the following Formula (1).

(HS)ₙ—R¹(P)ₘ Formula (1)

In Formula (1), R¹ represents a single bond or a 2 to 10 valent-linking group formed of nonmetallic atom(s); m and n each represent integers of from 1 to 9; and P represents a polymer skeleton.

In Formula (1), R¹ represents a single bond or a 2 to 10 valent-linking group formed of nonmetallic atom(s). More specifically, R¹ is formed of an atomic group including at least one of 1 to 100 carbon atoms, 0 to 10 nitrogen atoms, 0 to 50 oxygen atoms, 1 to 200 hydrogen atoms, and 0 to 20 sulfur atoms. More specific examples of the linking group include those configured by one or combination of any of the following structural units.

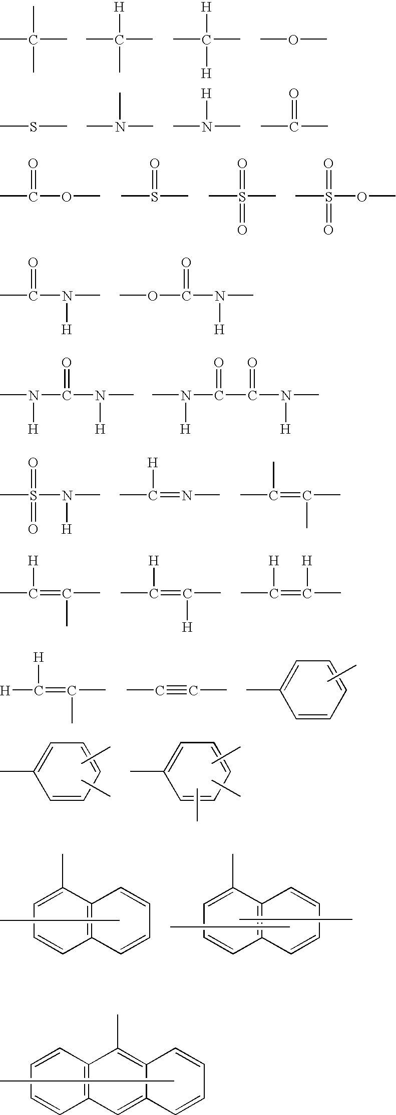

When the multi-valent linking group has a substituent(s), examples of the substituent(s) include: an alkyl group with 1 to 20 carbon atoms, such as a methyl group or an ethyl group; an aryl group with 6 to 16 carbon atoms, such as a phenyl group or a naphthyl group; an acyloxy group with 1 to 6 carbon atoms, such as a hydroxyl group, a carboxyl group, a sulfonamide group, an N-sulfonylamide group, or an acetoxy group; an alkoxy group with 1 to 6 carbon atoms, such as a methoxy group or an ethoxy group; a halogen atom such as chlorine or bromine; an alkoxycarbonyl group with 2 to 7 carbon atoms, such as a methoxycarbonyl group, an ethoxycarbonyl group, or a cyclohexyloxycarbonyl group; a cyano group; and a carbonate ester group such as t-butyl carbonate.

There are no particular limitations to the polymer skeleton represented by P in Formula (1). Preferable examples of the polymer skeleton include those selected from a (co)polymer of a vinylmonomer, an ester-containing polymer, an ether-containing polymer, a urethane-containing polymer, an amide-containing polymer, an epoxy-containing polymer, a silicon-containing polymer, and denatured compounds or copolymers thereof. More preferable examples of the polymer skeleton include those selected from a (co)polymer of a vinylmonomer, an ester-containing polymer, an ether-containing polymer, and denatured compounds or copolymers thereof.

Further, from the standpoint of the dispersibility of the metal particles and/or the metal compound particles, the polymer skeleton is preferably soluble in a solvent.

Examples of the polymer dispersant which may be used in the invention further include the polymer compounds represented by the following Formula (2).

(HS)ₙ—R²(S—R³—P)ₘ Formula (2)

In Formula (2), R² represents a single bond or a 2 to 10 valent-organic linking group formed of nonmetallic atom(s); R³ represents a single bond or a divalent organic linking group formed of nonmetallic atom(s); m and n each represent an integer of 1 to 9; and P represents a polymer skeleton.

R² in Formula (2) represents a single bond or a 2 to 10 valent-organic linking group formed of nonmetallic atom(s). More specifically, R² is formed of an atomic group including at least one of 1 to 60 carbon atoms, 0 to 10 nitrogen atoms, 0 to 50 oxygen atoms, 1 to 100 hydrogen atoms, and 0 to 20 sulfur atoms.

Specific examples of the 2 to 10 valent-organic linking group formed of nonmetallic atom(s) represented by R² include those configured by one or combination of any of the structural units exemplified as the specific examples of the linking group represented by R¹.

Preferable examples of organic linking group represented by R² among these are shown below, while the invention is not limited thereto.

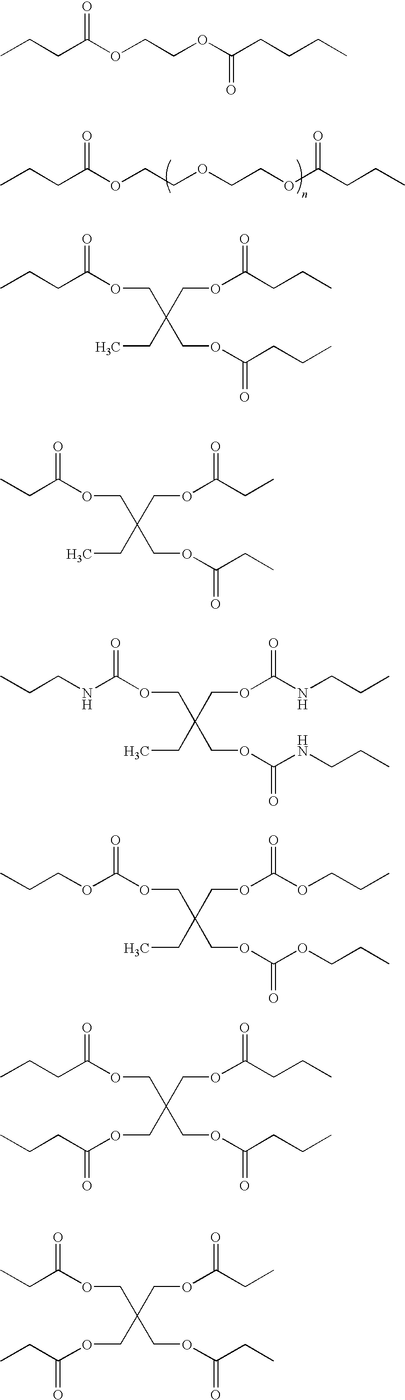

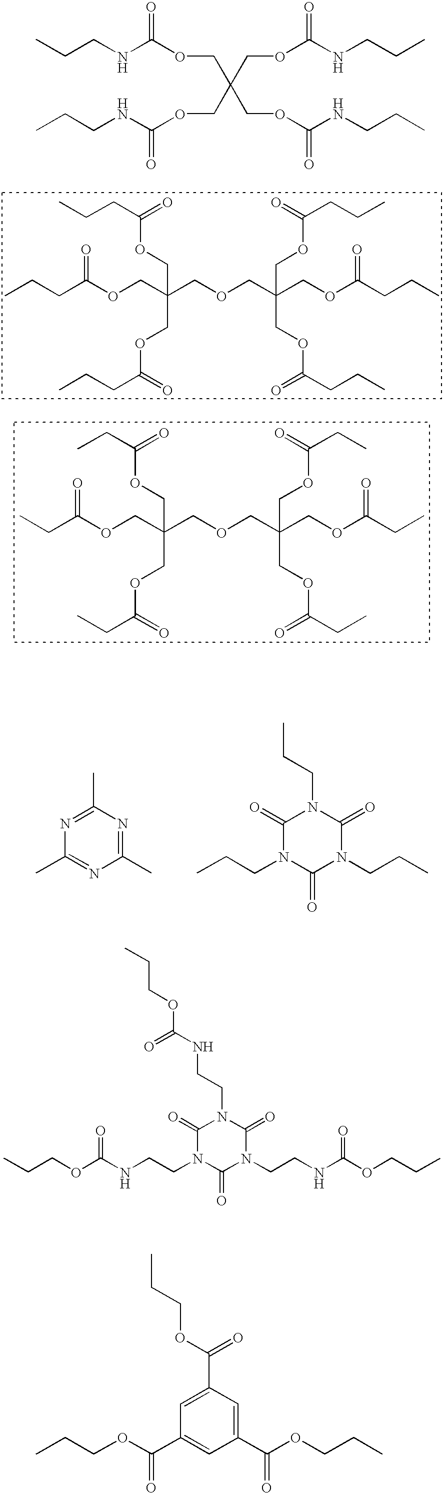

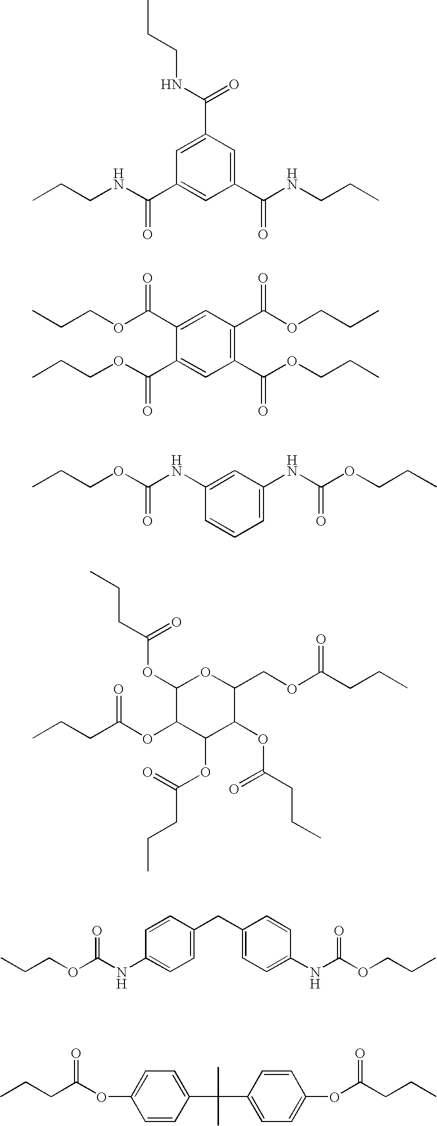

Among the specific examples of the linking group represented with R² that are shown in the above, those within dashed line boxes are particularly preferable from the standpoint of ease of synthesis and solubility in various solvents.

R³ in Formula (2) represents a single bond or a divalent organic linking group formed of nonmetallic atom(s). Preferable examples of R³ include: an unsubstituted or substituted straight chain, branched or cyclic alkylene group; an allylene group; a hetero allylene group; an aralkylene group; a divalent group which is one of the following, and a combination of two or more of the following, —S—, —C(═O)—, —N(R⁴)—, —SO—, —SO₂—, —CO₂—, and —N(R⁴) SO₂—. Examples of R⁴ within these divalent groups include a hydrogen atom and an alkyl group. Examples of the alkyl group include an alkyl group having 1 to 4 carbon atoms, such as a methyl group, an ethyl group, n-propyl group, an isopropyl group, n-butyl group, an isobutyl group, a sec-butyl group, or a t-butyl group.

In Formula (2), P is similar to P in Formula (1), and preferable examples thereof are also similar.

The polymer dispersant is a polymer compound which has one or more mercapto groups. The polymer compound may be synthesized by one of the following methods.

1. A method in which a functional group that has been introduced to a polymer terminus in advance is converted into a mercapto group.

2. A method described in JP-A No. 9-3108, which includes performing radical polymerization in the presence of a thiocarboxylic acid so as to introduce a thiocarboxylic acid ester to a terminus of a resultant, and then carrying out hydrolysis so as to synthesize a polymer which has one mercapto group at a terminus thereof.

3. A method in which a compound which has two or more mercapto groups in a single molecule and a polymer which has a carbon-carbon double bond at a terminus are made to react in the presence of a radical generator.

Among these methods, the method 3 of is preferable since plural functional groups are readily introduced to a polymer terminus.

The polymer dispersant which has two or more mercapto groups in a single molecule will now be explained. Examples of polymer compounds which can be used for the polymer dispersant include compounds which include plural of any of the following groups within their molecules: an aliphatic mercaptan group, an aromatic mercaptan group, and a mercapto group containing heterocycle.

Specific examples of the polymer dispersant include: compounds which have two mercapto groups, such as 1,2-ethanedithiol, 1,3-propanedithiol, 1,4-butanedithiol, 2,3-butanedithiol, 1,5-pentanedithiol, 1,6-hexane dithiol, 1,8-octanedithiol, 1,9-nonanedithiol, 2,3-dimercapto-1-propanol, dithioerythritol, 2,3-dimercaptosuccinic acid, 1,2-benzenedithiol, 1,2-benzenedimethanethiol, 1,3-benzenedithiol, 1,3-benzenedimethanethiol, 1,4-benzenedimethanethiol, 3,4-dimercaptotoluene, 4-chloro-1,3-benzenedithiol, 2,4,6-trimethyl-1,3-benzenedimethanethiol, 4,4′-thiodiphenol, 2-hexylamino-4,6-dimercapto-1,3,5-triazine, 2-diethylamino-4,6-dimercapto-1,3,5-triazine, 2-cyclohexylamino-4,6-dimercapto-1,3,5-triazine, 2-di-n-butylamino-4,6-dimercapto-1,3,5-triazine, ethylene glycol bis(3-mercaptopropionate), butanediol bis(mercaptoacetate), ethylene glycol bis(mercaptoacetate), 2,5-dimercapto-1,3,4-thiadiazole, 2,2′-(ethylenedithio) diethanethiol, or 2,2-bis(2-hydroxy-3-mercapto propoxyphenylpropane); compounds which have three mercapto groups, such as 1,2,6-hexanetriol trithioglycolate, 1,3,5-trithiocyanuric acid, 2,4,6-trimercapto-1,3,5-triazine, trimethylolpropane tris (3-mercaptopropionate), or trimethylolpropane tris (mercaptoacetate); and compounds which have four or more mercapto groups, such as pentaerythritol tetrakis (3-mercaptopropionate), pentaerythritol tetrakis (mercaptoacetate), dipentaerythritol hexakis (3-mercaptopropionate), or dipentaerythritol hexakis (mercaptoacetate).

The amount of the polymer dispersant contained in the raw material metal compound solution is preferably 5 weight % or above relative to the total of the metal amount by weight and the polymer dispersant amount by weight that are contained in the raw material metal compound solution. If the amount of the polymer dispersant is less than 5 weight %, then there may be a decline in the dispersion stability during reduction. There is no particular maximum to the amount of the polymer dispersant.

Examples of the process of reducing the metal compound in the method for producing the shape-anisotropic metal particles of the invention include: adding a reducing compound to a metal compound solution which contains the polymer dispersant; and adding a metal compound solution to a reducing compound solution containing the polymer dispersant. The former is preferable from the standpoint of dispersion stability. Furthermore, in the former case, it is also possible to use light, such as ultraviolet radiation, to carry out the reduction instead of using a reducing compound.

The former of the reduction processes will be explained below.

A polymer dispersant and an amine containing-compound are added to a solvent in which the metal compound is dissolved, and this is mixed uniformly. Or alternatively, the metal compound may be added to a solvent to which the polymer dispersant and the amine containing-compound have been added.

There are no particular limitations to the concentration of the metal in the metal compound solution for reduction. Usually, the metal concentration is preferably 10 mmol/l or higher. If the metal concentration is less than 10 mmol/l then the metallic colloidal solution obtained may have a too low metal concentration and not be effective. From the standpoint of raising the yield of the metal concentration, it is preferable that the metal concentration is 50 mmol/l or more, and it is more preferable that it is 140 mmol/l or more.

A reducing compound is added after uniformly mixing a polymer dispersant and an amine containing-compound with the metal compound solution. The reducing reaction may be carried out within the temperature range of from −20° C. to 300° C., and it is preferable to carry out the reducing reaction within the temperature range of from 0° C. to 100° C.

The amine containing-compound may also be used as a reducing agent. In such a case, the amine containing-compound is not mixed with the metal compound solution before the reducing reaction. The polymer dispersant and the metal compound solution are firstly mixed, and then the amine containing-compound is added thereto.

The content of the amine containing-compound is preferably 3% or above by volume, and more preferably 6% or above by volume, relative to the volume of the metal compound solution.

Examples of compounds which may be used for the reducing compound, in addition to amines, include: alkali metal borohydride salts, such as sodium borohydride; hydrazine compounds; citric acid; tartaric acid; ascorbic acid; formic acid; formaldehyde; dithionous acid; sulfoxylate salt compounds; hydroquinone; hydroquinone compounds; and hydroxyl acetone. These may be used singly, or in combination with the amine containing-compound.

Preferable examples of the reducing compound include triethanolamine, ascorbic acid, hydroquinone, hydroquinone compounds, and hydroxyl acetone. Among these hydroxyl acetone is still more preferable.

The amount of addition of the reducing compound is preferably equal to or more than the amount that is required to reduce the metal used to prepare the metal compound solution. If the amount is less than this, then there is a possibility that reduction may be insufficient. There is no particular maximum to the amount of the addition of the reducing compound.

It should be noted that, the latter process (adding the metal compound solution to a reducing compound solution containing a polymer dispersant) may also be performed according to processes similar to those of the former method.

The shape-anisotropic metal particles in the invention may be obtained in the form of plural spherical shaped particles connected at random in a chain. The diameter of each of the particle is preferably 2 nm to 50 nm, and more preferably 5 nm to 30 nm. The combination length of the particles is preferably 5 nm to 1,000 nm, with 5 nm to 500 nm being more preferable, and 10 nm to 300 nm being still more preferable.

The combination length of the shape-anisotropic metal particles is preferably as uniform as possible. The higher the mono-variance characteristics, the more suitably the particles may be used as a coloring material.

The combination length and the short axis length of the shape-anisotropic metal particles may be changed by varying the number, the molecular weight and the like of the terminus mercapto groups of the polymer dispersant. When a kind of the polymer dispersant is unchanged, the combination length and the short axis length of the shape-anisotropic metal particles may be changed by the amount of the polymer dispersant, the raw material metal compound concentration, the amine concentration, the amount of the reducing compound, and the temperature.

The metal concentration of metal in the metal particles obtained with the method for producing shape-anisotropic metal particles of the invention is preferably 80 weight %, more preferably 85 weight %, and further preferably 90 weight %.

The solid concentration of the metallic colloidal solution obtained by the method for producing shape-anisotropic metal particles of the invention is not particularly limited and, for example, may be 0.5 weight % to 60 weight %.

Since components such as ion impurities, such as acetate ions originating from the raw materials, salts that have been generated in the reduction, ions of amines when the amine is included, and alkalis when the amine is not added, excess reducing agent, or the like may cause adverse influence on the stability of the metal particle-containing liquid obtained with the method for producing shape-anisotropic metal particles of the invention, these components are preferably removed from the obtained metal particle-containing liquid. Examples of the method for removing these components include post treatment processes such as an electrodialysis, centrifugal separation, ultrafiltration or decantation. Centrifugal separation, ultrafiltration, decantation, and solvent extraction are preferable since the metal concentration of the metal particle-containing liquid is raised at the same time as removal is carried out thereby. Decantation is particularly preferable since no special apparatus is required and it is easily performed.

Metal particles may be readily formed into large aggregates in the raw material solution by adding, to the metal particle-containing liquid obtained with the manufacturing method of the shape-anisotropic metal particles solution of the invention, a poor solvent for the polymer dispersant. By carrying out repeated decantations of this aggregate several times with the poor solvent, unnecessary ions and the like may be removed and a slurry of aggregate obtained. In order to remove any of the poor solvent remaining in the aggregate slurry, the slurry may be dissolved in a re-dispersion solvent and decantation may be carried out with a solvent that is also able to dissolve the poor solvent. A metal particle aggregate slurry which can be dissolved in the re-dispersion solvent may be obtained according to such a process.

The solid content of the above aggregate slurry is preferably 30 weight % or above with respect to the slurry weight, more preferably 60 weight % or above, and further preferably 80 weight % or above is yet more preferable.

The poor solvent for the polymer dispersant is preferably one in which the above impurities dissolve.

After adding the poor solvent for the polymer dispersant into the metal particle-containing liquid and obtaining an aggregate, the aggregate may also be taken out by vacuum filtration and the like instead of decantation. When this is being done, a solvent which is able to remove the impurities and in which the aggregate is not dissolved is able to wash the aggregate to remove the impurities and a paste of the aggregate can be obtained. The pore size of the filter used for the vacuum filtration is preferably 100 μm or less, and is further preferably 30 μm or less.

While there are no particular limitations to the solid content of the paste of the aggregate, it is preferably 80 weight % or above with respect to the weight of the paste.

The dispersed metal particle-containing liquid may be obtained by adding a good solvent for the polymer dispersant to the aggregate of the metal particles. When this is being done, stirring, ultrasonic dispersion, bead mill dispersion, or the like may be performed in order to carry out re-dispersing the aggregate.

An amphiphilic solvent, such as acetone, is preferably used for synthesis of the metal particle-containing liquid. Moreover, it is also preferable that the reducing agent or the amine has amphipathic properties. In such cases, water is preferably used as the poor solvent for the polymer dispersant from the standpoint of ion removal and the like, and acetone, methanol, ethanol, propanol, or the like are preferably used as the washing solvent for removal of water.

It is also possible to dry the paste in order to remove the solvent, which becomes an impurity, from the paste of the aggregate of the metal particles.

The re-dispersion solvent which is a good solvent for the polymer dispersant may be a solvent that is different to the solvent that was used during reduction.

In addition, instead of the decantation, the centrifugal separation may also be used as a technique for sedimentation. In such cases it is preferable to carry out washing using a solvent several times so that impurities may be removed.

A solution with the polymer dispersant and plural metal particles that have been connected together may be obtained by carrying out the post treatment on the metal particle-containing liquid obtained by reducing a raw material metal compound in the presence of the polymer dispersant which has a mercapto group at a terminus thereof. When this is done, the concentration by weight of the polymer dispersant and the anisotropy metal particles may be derived from the solid content amount obtained from thermogravimetric-differential thermal analysis (TG-DTA) or the like.

The method for producing shape-anisotropic metal particles of the invention controls the number of connections of the particles of the connected metal colloid, that is to say controls the combination length and the particle size, and this may therefore be considered to be a control method of particle size and particle shape.

The shape-anisotropic metal particles of the invention impart a color tone which clearly changes with the combination length of the particles. Therefore, a coloring material which has a further different color tone may be obtained by mixing particles which have given color tones at given concentrations. For example, a black pigment may also be prepared by mixing together metal particles which have red, blue and green color tones.

The metal particle-containing liquid in the invention may be obtained by reducing a raw material metal compound, which has a mercapto group in its molecule, in the presence of the polymer dispersant, and a new polymer dispersant may be added thereto. When a new polymer dispersant is not added, the metal concentration of the metal particle-containing liquid may be dramatically increased in comparison with the metal concentration of a metal particle-containing liquid obtained by a conventional method. Therefore, when forming a thin film using these metal particles as a coloring material, the film thickness may be decreased dramatically in comparison with previous cases. Furthermore, there is also the merit that these particles may be used with low heat-resistant materials, since the heating conditions for imparting conductivity may be made milder when these metal particles are used to form a conductive material during film forming.

Coloring Composition

The coloring composition of the invention is obtained by containing shape-anisotropic metal particles produced by the method of the invention in a solvent having an SP value of 25.8 MPa^{1/2} or less. In other words, the coloring composition of the invention contains at least one kind of the shape-anisotropic metal particles of the invention. The coloring composition of the invention may also include, as required, pigment particles, a polymer binder, a photopolymerizable monomer, a photopolymerization initiator, a solvent, and/or the like.

SP value (solubility parameter) refers to a numerical value defined by the square root of the cohesive energy density, and this represents the intermolecular forces of the solvent. This SP value is one way to quantify the polarity of polymers and low-molecular compounds, such as solvents, and can be derived by the calculation shown below, or through experimental observation.

SP value(δ)=(ΔEv/V)^{1/2}

In the above equation, ΔEv represents the molar energy of vaporization and V represents the molar volume.

Furthermore, for the above ΔEv and V, the sum total (ΔEv) of the molar heat of vaporization (Δei) of the groups of atoms, and the sum total (V) of the molar volumes (vi) as described in “Polymer Engineering and February” by Robert F. Fedors (Vol. 14, No. 2, pages 151 to 153, 1974) may also be used.

Examples of solvents having SP values of 25.8 MPa^{1/2} or less include: methyl ethyl ketone, 1-propanol, propylene glycol monomethyl ether acetate, acetone, cyclohexanone, n-methyl-pyrrolidone, and 2-propanol. Particularly preferable examples among these include methyl ethyl ketone, 1-propanol, propylene glycol monomethyl ether acetate, and cyclohexanone.

The coloring composition of the invention may be used for printing inks, inkjet inks, materials for photomask production, proof production materials for printing, etching resists, solder resists, the partition walls of plasma-display panels (PDP), dielectric patterns, electrode (conductor circuit) patterns, wiring pattern of electronic components, conductive pastes, electrically conducting films, and in light-blocking images such as black matrixes.

The coloring composition of the invention may be preferably used at portions between color patterns and in surrounding frames in order to improve the display properties of color filters used for displays and the display properties of color liquid crystal displays and the like that use color filters, and the coloring composition of the invention may be preferably used to provide light-blocking images such as on the outdoor daylight side of TFTs.

The coloring composition of the invention may be used further preferably for the black portions of the black frame provided around the periphery of displays, such as liquid crystal displays, plasma displays, EL displays, or CRT display units, and in the lattice or stripe shapes between the red, blue and green pixels therein.

The coloring composition of the invention is particularly preferably used for black matrixes such as of dot shape or stripe shape black patterns for light-blocking in TFTs.

Coloring Composition for Light-Blocking Image Production

A detailed explanation will now be given of the coloring composition, and in particular the use of the coloring composition for light-blocking image production.

The optical density per 1 μm of film thickness of a light-blocking layer is preferably 1 or greater when a light-blocking layer (layer before patterning) is formed using the coloring composition for light-blocking image production. When consideration is made for preventing metal particles from fusing during heat processing in color filter production, the amount of the shape-anisotropic metal particles contained in the coloring composition is preferably adjusted so that the contained amount of the shape-anisotropic metal particles in the light-blocking layer formed is 10 to 90 weight % with respect to the total weight of the light-blocking layer, and it is more preferably adjusted so as to be about 10 to 80 weight %. It is also preferable to adjust the above contained amount with consideration to the change in the optical density that occurs with the average particle size of the shape-anisotropic metal particles.

Similar conditions can be applied to the amount of the shape-anisotropic metal particles contained in the photosensitive coloring composition which will be described later.

Black matrixes (sometimes referred to below simply by “BM”) are included within the scope of “light-blocking images” as used in the invention. “BM” include black portions provided around the periphery of display devices, such as liquid crystal displays, plasma displays, EL displays, and CRT display units, and in the lattice or stripe shapes between the red, blue and green pixels therein. BM further include the dot shape or stripe shape black patterns for light-blocking in TFTs, and this definition of BM is given, for example, in “Dictionary of Liquid Crystal Display Manufacturing Apparatus Terms” by Taihei Kanno, 2nd edition, published by Nikkan Kogyo Shimbun, 1996 at p. 64. Examples of light-blocking images include organic EL displays (shown in, for example, JP-A No. 2004-103507) and PDP front panels (shown in, for example, JP-A No. 2003-51261), and of backlight light-blocking include plasma address liquid crystals (PALC), and the like.

High light-blocking ability (an optical density (OD) of 3 or more) is required for a BM in order to raise display contrast, and in order to prevent the image quality degradation by current leakage caused by light, in the case of liquid crystal displays using an active matrix driving method with thin film transistors (TFT).

From a standpoint of the transmission optical density (O.D.) of a light-blocking layer, the shape-anisotropic metal particles used for the coloring composition for light-blocking image production of the invention are preferably silver particles with a short axis length of from 4 nm to 100 nm, and further preferably silver particles with a short axis length of from 10 nm to 30 mm.

The shape-anisotropic metal particles are preferably in a dispersed state in the invention. There are no particular limitations to the state that the shape-anisotropic metal particles are in when dispersed, while it is preferable that the shape-anisotropic metal particles exists in a stable dispersion state and, for example, a colloidal state thereof is more preferable. When the shape-anisotropic metal particles are in colloidal states, for example, it is preferable that the shape-anisotropic metal particles are substantially dispersed in the state of particles which have shape anisotropy.

In such cases, the polymer dispersant which has a mercapto group used for preparing the particle-containing liquid may be added, and/or another kind of dispersant may be added. Examples of the another kinds of dispersant include: thiol group containing compounds; amino acids and modified compounds thereof; peptide compounds; polysaccharides and naturally-occurring polymers of polysaccharide origin; synthetic polymers and gels derived therefrom.

There are no particular limitations to the kind of thiol group containing compound used here and any compound which has one or more thiol groups may be used. Examples of thiol group containing compounds include, but are not limited to: alkyl thiols (for example, methyl mercaptan, ethyl mercaptan and the like); aryl thiols (for example, thiophenol, thionaphthol, benzyl mercaptan, and the like); amino acids or compounds thereof (for example, cysteine, glutathione, and the like); and peptide compounds (for example, dipeptide compounds, tripeptide compounds and tetra peptide compounds containing a cysteine residue, and oligopeptide compounds containing five or more amino acid residues); and proteins (for example, globular proteins in which a metallothionein and/or cysteine residue has been disposed on the surface thereof).

Examples of polymers used for the dispersant include polymers with protective colloid properties such as gelatin, polyvinyl alcohols, methyl cellulose, hydroxylpropylcellulose, polyalkylene amine, partially-alkylated esters of polyacrylic acid, and PVP and PVP copolymers. Polymers which may be used as the dispersant are described in, for example, “Dictionary of Pigments” edited by Seijiro ITOH, published by Asakurashoin, 2000).

Moreover, a hydrophilic polymer, a surfactant, a preservative, and/or a stabilizer may be appropriately blended with the dispersion liquid. Any kind of hydrophilic polymer may be used, as long as it is able to dissolve in water, and as long as a solution state may be substantially maintained when in a diluted state. Examples of the hydrophilic polymers include: proteins and substances of protein origin, such as gelatins, collagens, caseins, fibronectins, laminin or elastin; naturally-occurring polymers such as polysaccharides or substances of polysaccharide origin, such as cellulose, starch, agarose, carrageenan, dextran, dextrin, chitin, chitosan, pectin, or mannan; synthetic polymers, such as poval, polyacrylamide, polyvinylpyrrolidone polyacrylate, polyethylene glycol, polystyrene sulfonate, or allylamines; and gels derived therefrom. There are no particular limitations to the kind of gelatin when gelatin is used, and examples thereof include alkali treated cow bone gelatin, alkali treated pig skin gelatin, acid treated cow bone gelatin, phthalated cow bone treated gelatin, and acid treated pig skin gelatin.

Anionic surfactants, cationic surfactants, nonionic surfactants, and betaine surfactants may be used as the surfactant, with anionic surfactants and nonionic surfactants being particularly preferable. The hydrophilic-lipophilic balance (HLB) value of the surfactant depends on whether it is an aqueous or organic solvent-containing coating liquid and so a single value cannot be given, while a surfactant with an HLB of about 8 to about 18 is preferable when the solvent is a water-containing solvent, and a surfactant with an HLB of about 3 to about 6 is preferable when the solvent is an organic solvent-containing solvent.

It should be noted that there are descriptions of the HLB values in, for example, “The Surfactant Handbook” (edited by Tokiyuki YOSHIDA, Shiichi SHINDO and Mikiyoshi YAMANAKA, published by Kougaskutosho Co., Ltd. 1987). Specific examples of the surfactants include propylene glycol monostearate, propylene glycol monolaurate, diethylene glycol monostearate, sorbitan monolaurate, polyoxyethylene sorbitan monolaurate, and the like. Descriptions related to examples of the surfactant are given in the “Surfactant Handbook”.

Pigment

A colorless black may be obtained by including a pigment used in the coloring composition of the invention.

Pigments may be broadly classified into organic pigments and inorganic pigments. Organic pigments are preferable in the invention. Examples of the pigments that may be preferably used include azo pigments, phthalocyanine pigments, anthraquinone pigments, dioxazine pigments, quinacridone pigments, isoindolinone pigments, and nitro pigments. Preferable examples of the hue of such organic pigments include yellow pigments, orange pigments, red pigments, violet pigments, blue pigments, green pigments, brown pigments, and black pigments.

It should be noted that a pigment preferably used for light-blocking image production includes least one selected from carbon black, titanium black, and graphite.

Examples of pigments which can be used in a photosensitive resin layer are listed below, arranged according to their hues, while the invention is not limited by these.

1) Red Pigments

Organic pigments, such as CI Pigment Red 9, CI Pigment Red 97, CI Pigment Red 122, CI Pigment Red 123, CI Pigment Red 149, CI Pigment Red 168, CI Pigment Red 177, CI Pigment Red 180, CI Pigment Red 192, CI Pigment Red 215, CI Pigment Red 216, CI Pigment Red 217, CI Pigment Red 220, CI Pigment Red 223, CI Pigment Red 224, CI Pigment Red 226, CI Pigment Red 227, CI Pigment Red 228, CI Pigment Red 240, CI Pigment Red 48:1, CI Pigment Red 209, CI Pigment Red 146, CI Pigment Red 11, CI Pigment Red 81, CI Pigment Red 123, CI Pigment Red 213, CI Pigment Red 272, CI Pigment Red 270, CI Pigment Red 255, CI Pigment Red 264, CI Pigment Red 254, CI No. 12085, CI No. 12120, CI No. 12140, or CI No. 12315.

2) Green Pigments

Organic pigments, such as CI Pigment Green 7, CI Pigment Green 36, CI No. 42053, CI No. 42085, or CI No. 42095

3) Blue Pigments

Organic pigments, such as CI Pigment Blue 15, CI Pigment Blue 15:1, CI Pigment Blue 15:4, CI Pigment Blue 15:6, CI Pigment Blue 22, CI Pigment Blue 60, CI Pigment Blue 64, CI No. 42052 or CI No. 42090.

4) Yellow Pigments

Pigment Yellow 12 (CI No. 21090), such as Permanent Yellow DHG (trade name, made by Clariant Japan KK), Lionol Yellow 1212B (trade name, made by Toyo Ink Manufacturing Co., Ltd.), Irgalite® Yellow LCT (trade name, made by Chiba Specialty Chemicals Co., Ltd.), Symuler Fast Yellow GTF 219 (trade name, made by Dainippon Ink and Chemicals, Inc.); Pigment Yellow 13 (CI No. 21100), such as Permanent Yellow GR (trade name, made by Clariant Japan KK) or Lionol Yellow 1313 (trade name, made by Toyo Ink Manufacturing Co., Ltd.); Pigment Yellow 14 (CI No. 21095), such as Permanent Yellow G (trade name, made by Clariant Japan KK) and Lionol Yellow 1401-G (trade name, made by Toyo Ink Manufacturing Co., Ltd.) and Seika Fast Yellow (Seika Fast Yellow) 2270 (trade name, made by Dainichiseika Color & Chemicals Manufacturing Co., Ltd.) or Symuler Fast Yellow 4400 (trade name, made by Dainippon Ink and Chemicals, Inc.);

Pigment Yellow 17 (CI No. 21105), such as Permanent Yellow GG02 (trade name, made by Clariant Japan KK) or Symuler Fast Yellow 8GF (trade name, made by Dainippon Ink and Chemicals, Inc.);

Pigment Yellow (Pigment Yellow) 155, such as Graphtol Yellow 3GP (trade name, made by Clariant Japan KK);

Pigment Yellow 180 (CI No. 21290), such as Novoperm Yellow P-HG (trade name, made by Clariant Japan KK) or PV Fast Yellow HG (trade name, made by Clariant Japan KK);

Pigment Yellow 139 (CI No. 56298), such as Novoperm Yellow M2R 70 (trade name, made by Clariant Japan KK);

CI Pigment Yellow 20; CI Pigment Yellow 24; CI Pigment Yellow 17; CI Pigment

Yellow 83; CI Pigment Yellow 86; CI Pigment Yellow 93; CI Pigment Yellow 109; CI Pigment Yellow 110; CI Pigment Yellow 117; CI Pigment Yellow 125; CI Pigment Yellow 137; CI Pigment Yellow 138; CI Pigment Yellow 139; CI Pigment Yellow 185; CI Pigment Yellow 147; CI Pigment Yellow 148; CI Pigment Yellow 153; CI Pigment Yellow 154; CI Pigment Yellow 166; CI Pigment Yellow 168; and CI Pigment Yellow 185.

5) Magenta Pigments

Pigment Red 57:1 (CI No. 15850:1), such as Graphtol Rubine L6B (trade name, made by Clariant Japan KK). Lionol Red 6B-4290 g (trade name, made by Toyo Ink Manufacturing Co., Ltd.) or Irgalite® Rubine 4BL (trade name, made by Chiba Specialty Chemicals Co., Ltd.), or Symuler Brilliant Carmine 6B-229 (trade name, made by Dainippon Ink and Chemicals, Inc.);

Pigment Red (Pigment Red) 122 (CI No. 73915), such as Hosterperm Pink E (trade name, made by Clariant Japan KK) and Lionogen Magenta 5790 (trade name, made by Toyo Ink Manufacturing Co., Ltd.) or Fastogen Super Magenta RH (trade name, made by Dainippon Ink and Chemicals, Inc.);

Pigment Red 53:1 (CI No. 15585:1), such as Permanent Lake Red LCY (trade name, made by Clariant Japan KK) or Symuler Lake Red C conc (trade name, made by Dainippon Ink and Chemicals, Inc.);

Pigment Red 48:1 (CI No. 15865:1), such as Lionol Red 2B 3300 (trade name, made by Toyo Ink Manufacturing Co., Ltd.) or Symuler Red NRY (trade name, made by Dainippon Ink and Chemicals, Inc.);

Pigment Red (Pigment Red) 48:2 (CI No. 15865:2), such as Permanent Red W2T (trade name, made by Clariant Japan KK), Lionol Red LX235 (trade name, made by Toyo Ink Manufacturing Co., Ltd.) or Symuler Red 3012 (trade name, made by Dainippon Ink and Chemicals, Inc.);

Pigment Red (Pigment Red) 48:3 (CI No. 15865:3), such as Permanent Red 3RL (trade name, made by Clariant Japan KK) or Symuler Red 2BS (trade name, made by Dainippon Ink and Chemicals, Inc.); and

Pigment Red 177 (CI No. 65300), such as Cromophtal® Red A2B (trade name, made by Chiba Specialty Chemicals Co., Ltd.). 6) Cyan Pigments

Pigment Blue 15 (CI No. 74160), such as Lionol Blue 7027 (trade name, made by Toyo Ink Manufacturing Co., Ltd.) or Fastogen Blue BB (trade name, made by Dainippon Ink and Chemicals, Inc.);

Pigment Blue 15:1 (CI No. 74160), such as Hosterperm Blue A2R (trade name, made by Clariant Japan KK) or Fastogen Blue 5050 (trade name, made by Dainippon Ink and Chemicals, Inc.);

Pigment Blue 15:2 (CI No. 74160), such as Hosterperm Blue AFL (trade name, made by Clariant Japan KK), Irgalite® Blue BSP (trade name, made by Chiba Specialty Chemicals Co., Ltd.) or Fastogen Blue (Fastogen Blue) GP (trade name, made by Dainippon Ink and Chemicals, Inc.);

Pigment Blue 15:3 (CI No. 74160), such as Hosterperm Blue B-2 g (trade name, made by Clariant Japan KK), Lionol Blue FG7330 (trade name, made by Toyo Ink Manufacturing Co., Ltd.) Cromophtal® Blue 4GNP (trade name, made by Chiba Specialty Chemicals Co., Ltd.) or Fastogen Blue FGF (trade name, made by Dainippon Ink and Chemicals, Inc.);

Pigment Blue 15:4 (CI No. 74160), such as Hosterperm Blue BFL (trade name, made by Clariant Japan KK), Cyanine Blue 700-10FG (trade name, made by Toyo Ink Manufacturing Co., Ltd.). Irgalite® Blue GLNF (trade name, made by Chiba Specialty Chemicals Co., Ltd.) or Fastogen Blue FGS (trade name, made by Dainippon Ink and Chemicals, Inc.);

Pigment Blue (Pigment Blue) 15:6 (CI No. 74160), such as Lionol Blue (Lionol Blue) ES (trade name, made by Toyo Ink Manufacturing Co., Ltd.); and

Pigment Blue 60 (CI No. 69800), such as Hosterperm Blue RL01 (trade name, made by Clariant Japan KK) or Lionogen Blue 6501 (trade name, made by Toyo Ink Manufacturing Co., Ltd.).

7) Brown Pigments and Black Pigments CI Pigment Brown 23, CI Pigment Brown 25, CI Pigment Brown 26, and Pigment Black 7 (carbon black CI No. 77266), TiO₂, TiO, TiN and mixtures thereof, and graphite, such as Mitsubishi Carbon Black MA100 (trade name, made by Mitsubishi Chemical Corporation), Mitsubishi Carbon Black #5 (trade name, made by Mitsubishi Chemical Corporation), Black Pearls® 430 (trade name, made by Cabot Corporation), or 12S and 12M (both trade names, made by Mitsubishi Materials Corporation)).

8) Orange Pigments

CI pigment oranges such as CI Pigment Orange 36, CI Pigment Orange 43, CI Pigment Orange 51, CI Pigment Orange 55, CI Pigment Orange 59, and CI Pigment Orange 61.

9) Violet Pigments

CI Pigment Violet 19, CI Pigment Violet 23, CI Pigment Violet 29, CI Pigment Violet 30, CI Pigment Violet 37, CI Pigment Violet 40, and CI Pigment Violet 50.

Moreover, examples of pigments which may be used in the invention include products which are suitably selected with reference to: the “Pigment Manual”, edited by the Japanese Pigment Technical Society, published by Seibundo Shinkosha, 1989; “Colour Index, the Society of Dyes & Colourist, Third Edition, 1987”; or the like.

In the invention, phthalocyanine pigments are preferable from the above, and examples thereof include pigments which have acidic groups, such as CI Pigment Yellow 138, CI Pigment Yellow 139, CI Pigment Yellow 150, CI Pigment Yellow 185, CI Pigment Yellow 83 or the like. Particularly preferable examples thereof include CI Pigment Yellow 138, CI Pigment Yellow 139, CI Pigment Yellow 150, CI Pigment Yellow 185, CI Pigment Yellow 83, CI Pigment Red 254, CI Pigment Green 36, CI Pigment Blue 15, and carbon black.

Pigments with a hue that is in a complementary color relationship to the hue of the anisotropy metal particles are preferably used in the invention. The pigments may be used singly or in combinations of two or more. Preferable examples of the combination of the pigments include: a pigment combination of a pigment mixture of a red-series pigment or a blue-series pigment which have a complementary color relationship to each other with a pigment mixture of a yellow-series pigment and a purple-series pigment which have a complementary color relationship to each other; a combination of the pigment combination with a further added black-series pigment; and a pigment combination of a blue-series pigment, a purple-series pigment and a black-series pigment. The amount of the pigment contained in the light-blocking layer is preferably in the range of 1 weight % to 70 weight %, more preferably in the range of 1 weight % to 40 weight %, and further preferably in the range of 1 weight % to 20 weight %, relative to the total amount of the light-blocking layer.

The pigment is preferably dispersed uniformly in the coloring composition for light-blocking image production. The average particle size of the pigment is preferably 5 μm or less, and is particularly preferably 1 μm or less. Furthermore, the average particle size of the pigment for color filters is preferably 0.5 μm or less.

Coloring Composition for Photosensitive Light-Blocking Image Production

The coloring composition for light-blocking image production of the invention is preferably photosensitive. Photosensitivity may be imparted to the coloring composition for light-blocking image production of the invention by adding a photosensitive resin composition. The scope of the photosensitive resin composition include an alkali soluble binder polymer, a photopolymerization initiator, and a monomer that has an ethylenically unsaturated double bond and is addition polymerizable by light irradiation (sometimes referred to below as “photopolymerizable monomers”).

The scope of the photosensitive resin composition include alkaline aqueous solution-developable compositions and organic solvent-developable compositions. Alkaline aqueous solution-developable compositions are preferable from the point of view of safety and the cost of the developer.

The photosensitive resin composition may be either a negative-working composition in which the portions which receive radiation such as light or an electron beam are hardened or a positive-working composition in which the non-radiation-receiving portions are hardened.

Examples of the positive-working photosensitive resin composition include compositions that use novolak resins. For example, an alkali soluble novolak resin described in JP-A No. 7-43899 may be used. Moreover, a positive-working photosensitive resin layer described in JP-A No. 6-148888 may be used, this photosensitive resin layer being a photosensitive resin layer which contains an alkali soluble resin described in this publication and 1,2-naphthoquinone diazide sulfonate ester as a photosensitizer. Furthermore, a composition described in JP-A No. 5-262850 is also utilizable.

Examples of the negative-working photosensitive resin compositions include: a photosensitive resin composition formed from a negative-working diazo resin and a binder; a photopolymerizable composition; a photosensitive resin composition formed from an azide compound and a binder; and cinnamic acid photosensitive resins. Particularly preferable among these is a photopolymerizable composition which contains a photopolymerization initiator, a photopolymerizable monomer, and a binder as basic structural components thereof. Examples of the photopolymerizable compositions also include “polymerizable compound B”, “polymerization initiator C”, a “surfactant” and a “bonding agent” described in JP-A No. 11-133600.

Examples of the photosensitive resin composition which is negative-working and is developable in an alkaline aqueous solution include that having, as principal components thereof, a binder containing an carboxylic acid group (an alkali soluble binder, such as the alkali soluble thermoplastic resins), a photopolymerization initiator, and a monomer containing an ethylenically unsaturated double bond which can carry out addition polymerization by light irradiation (sometimes referred to below as a “photopolymerizable monomer”).

Examples of the alkali soluble binder include a polymer having a carboxylic acid group in a side chain thereof. Specific examples thereof include the methacrylic acid copolymers, acrylic acid copolymers, itaconic acid copolymers, crotonic acid copolymers, maleic acid copolymers, partially esterified maleic acid copolymers and the like described in JP-A No. 59-44615, JP-B No. 54-34327, JP-B No. 58-12577, JP-B No. 54-25957, JP-A No. 59-53836, or JP-A No. 59-71048. Moreover, cellulose compounds which have a carboxylic acid group in a side chain thereof are also included as examples of the alkali soluble binder.

In addition, binders in which a cyclic anhydride is added to a polymer which has a hydroxyl group are also preferably used. Particular Examples of the alkali soluble binder include the copolymers of benzyl (meth)acrylate and (meth)acrylate, and the multi-copolymers of benzyl (meth)acrylate, (meth)acrylate, and other monomers, which are described in the specification of U.S. Pat. No. 4,139,391.

Polymers that have an acid value in the range of from 30 mgKOH/g to 400 mgKOH/g, and that have a weight average molecular weight in the range of from 1,000 to 300,000 are preferably selected and used as the alkali soluble binder polymer. An alkali insoluble polymer may be added in order to improve various performance characteristic such as the strength of the hardening layer or the like, as long as it is added within a range which does not have an adverse influence on the developing properties or the like. Examples of the alkali soluble binder polymers also include alcohol soluble nylon and epoxy resins.

The contained amount of the alkali soluble binder polymer is usually preferably in the range of from 10 weight % to 95 weight %, and more preferably in the range of from 20 weight % to 90 weight % with respect to the total solids of a photosensitive resin composition. In the range of from 10 weight % to 95 weight %, the adhesiveness of the photosensitive resin layer may not too high, and the strength and photosensitivity of the formed layer may not deteriorate.

Examples of the photopolymerization initiators include: the vicinal polyketaldonyl compound described in the specification of U.S. Pat. No. 2,367,660; the acyloin ether compound described in the specification of U.S. Pat. No. 2,448,828; the aromatic acyloin compound substituted with an α-hydrocarbon described in the specification of U.S. Pat. No. 2,722,512; the polynuclear quinone compound described in each of the specifications of U.S. Pat. No. 3,046,127 and 2,951,758; the combination of a triaryl imidazole dimer and p-aminoketone described in the specification of U.S. Pat. No. 3,549,367; the benzothiazole compound and trihalomethyl-s-triazine compound described in JP-B No. 51-48516; the trihalomethyl-s-triazine compound described in the specification in U.S. Pat. No. 4,239,850; and the trihalomethyl oxadiazole compound described in the specification of U.S. Pat. No. 4,212,976. Particularly preferable examples thereof include trihalomethyl-s-triazine, trihalomethyl oxadiazole, and a triaryl imidazole dimer.

In addition, the “polymerization initiator C” described in JP-A No. 11-133600 is also included as a preferable example.

These photopolymerization initiators or photopolymerization initiator systems may be used singly or in mixtures of two or more, it being particularly preferable to use two more thereof. Moreover, the contained amount of the photopolymerization initiator is usually from 0.5 weight % to 20 weight %, and is preferably from 1 weight % to 15 weight % with respect to the total solids of the photosensitive resin composition.

Examples of a photopolymerization initiator with high light-exposure sensitivity, little coloring with a yellowish tinge, and good display properties include combinations of a diazole-containing photopolymerization initiator and a triazine-containing photopolymerization initiator. The best combination among these is a combination of 2-trichloromethyl 5-(p-styrylmethyl)-1,3,4-oxadiazole and 2,4-bis (trichloromethyl)-6-[4-(N,N-diethoxy carbonylmethyl)-3-promo phenyl]-s-triazine.

The ratio of these photopolymerization initiators in terms of the diazole-containing initiator/triazine-containing initiator based on weight is preferably from 95/5 to 20/80, is more preferably from 90/10 to 30/70, and is most preferably from 80/20 to 60/40.

These photopolymerization initiators are described in JP-A No. 1-152449, JP-A No. 1-254918, and JP-A No. 2-153353.

Preferable examples of initiators also include benzophenone-containing initiators.

When the proportion the pigment occupies of the total solids content of the coloring composition for light-blocking image production is near to from 15 weight % to 25 weight %, the same effect may be obtained by mixing a coumalin compound into the photopolymerization initiators. The best example of the coumalin compound is 7-[2-[4-(3-hydroxymethyl piperidino)-6-diethylamino]triazinylamino]-3-phenylcoumarin.

The ratio of the photopolymerization initiators to the coumalin compound is, in terms of the weight ratio of photopolymerization initiator/phenyl-containing compound, preferably from 20/80 to 80/20, is more preferably from 30/70 to 70/30, and is most preferably from 40/60 to 60/40.

It should be noticed that the photopolymerizable composition which may be used for the invention is not limited to the above, and may be suitably chosen from known compositions.

The photopolymerization initiator is usually from 0.5 weight % to 20 weight %, and preferably from 1 weight % to 15 weight %, with respect to the total solids of the photosensitive resin composition. When the contained amount is in the above range, the photosensitivity and strength of an image may be prevented from falling, and the performance thereof may be sufficiently raised.

Examples of the photopolymerizable monomer include compounds with boiling temperatures at normal pressure of 100° C. or above. Specific examples thereof include: monofunctional (meth)acrylates, such as polyethylene glycol mono(meth)acrylate, polypropylene glycol mono(meth)acrylate or phenoxyethyl (meth)acrylate; and polyfunctional (meth)acrylates such as polyethylene glycol di(meth)acrylate, polypropylene glycol di(meth)acrylate, trimethylolethane triacrylate, trimethylolpropane triacrylate, trimethylolpropane diacrylate, neopentyl glycol di(meth)acrylate, pentaerythritol tetra(meth)acrylate, pentaerythritol tri(meth)acrylate, dipentaerythritol hexa(meth)acrylate, dipentaerythritol penta(meth)acrylate, hexanediol di(meth)acrylate, trimethylolpropane tri (acryloyloxypropyl)ether, tri(acryloyloxyethyl) isocyanurate, tri(acryloyloxyethyl) cyanurate, glycerol tri(meth)acrylate, and polyfunctional (meth)acrylates that have been formed by addition reaction of ethylene oxide or propylene oxide with a polyfunctional alcohol, such as trimethylolpropane or glycerin, and then (meth)acrylization carried out to the resultant therefrom.

Examples of the photopolymerizable monomer also include: urethane acrylates described in JP-B No. 48-41708, JP-B No. 50-6034 and JP-A No. 51-37193; polyfunctional acrylates and methacrylates, such as the polyester acrylates described in publication of JP-A No. 48-64183, JP-B No. 49-43191, and JP-B No. 52-30490; and epoxy acrylates which are the resultant products of reacting together an epoxy resin and a (meth)acrylate. Preferable examples among these include trimethylolpropane tri(meth)acrylate, pentaerythritol tetra(meth)acrylate, dipentaerythritol hexa(meth)acrylate, and dipentaerythritol penta(meth)acrylate. The photopolymerizable monomers may be used singly, or used in combinations of two or more thereof mixed together. The contained amount of the photopolymerizable monomer with respect to the total solids of the photosensitive resin composition is usually from 5 weight % to 50 weight %, and is preferably from 10 weight % to 40 weight %. If the contained amount is in the above ranges then photosensitivity and the strength of images formed does not deteriorate, and the adhesiveness of the photosensitive light-blocking layer does not become too adhesive.

The photosensitive resin composition preferably further includes a thermal-polymerization inhibitor in addition to the above components. Examples of the thermal-polymerization inhibitor include: aromatic hydroxy compounds, such as hydroquinone, p-methoxyphenol, p-t-butylcatechol, 2,6-di-t-butyl-p-cresol, β-naphthol or pyrogallol; quinones, such as benzoquinone or p-toluquinone; amines, such as naphthylamine, pyridine, p-toluidine, or phenothiazin; aluminium salts or ammonium salts of N-nitrosophenylhydroxylamine; chloranil; nitrobenzene; 4,4′-thiobis (3-methyl-6-t-butylphenol); 2,2′-methylenebis (4-methyl-6-t-butylphenol); 2-mercaptobenzimidazole and the like.

Known additives such as a plasticizer, a surfactant, an adhesion promoter, a dispersant, a sagging inhibitor, a leveling agent, an antifoaming agent, a fire retardant, a brightening agent, or a solvent may also be added in the photosensitive resin composition if necessary.

Examples of the adhesion promoter include alkylphenol/formaldehyde novolak resins, polyvinyl ethyl ether, polyvinyl isobutyl ether, polyvinyl butyral, polyisobutylene, styrene-butadiene copolymer rubbers, butyl rubber, vinyl chloride-vinyl acetate copolymers, chlorinated rubbers, acrylic resin-containing adhesives, aromatic petroleum resins, aliphatic petroleum resins, alicyclic petroleum resins, and silane coupling agents.

Moreover, when the shape-anisotropic metal particles of the invention are used as an aqueous dispersion such as a silver colloid, the photosensitive resin compositions should be a water-containing composition. Examples of the photosensitive resin compositions include those compositions described in paragraphs [0015] to [0023] of JP-A No. 8-271727, and also commercially available products such as “SPP-M20” (trade name, made by Toyo Gosei Co., Ltd).

By forming a black matrix using the coloring composition for light-blocking image production of the invention (including photosensitive compositions thereof), a black matrix with a thin film and a high optical density can be produced.

Photosensitive Transfer Material for Light-Blocking Image Production

A photosensitive transfer material for light-blocking image production of the invention may be produced using the photosensitive coloring composition for light-blocking image production, and a light-blocking image, such as a black matrix, may be produced using the photosensitive transfer material for light-blocking image production.

The photosensitive transfer material is one that is prepared with a photosensitive light-blocking layer formed on a support using at least the photosensitive coloring composition for light-blocking image production, and the photosensitive transfer material for light-blocking image production may also be provided with thermoplastic resin layer(s), intermediate layer(s), or protective layer(s) as required.

The film thickness of the photosensitive light-blocking layer is preferably in the range of from 0.2 μm to 2 μm, and is more preferably from 0.2 μm to 0.9 μm.

Support

Examples of the support usable in the invention include known supports, such as those formed of polyester or polystyrene. Biaxially extended polyethylene terephthalate is especially preferable from the standpoints of cost, heat resistance, and dimensional stability. The thickness of the support is preferably from about 15 μm to about 200 μm, and more preferably from about 30 μm to about 150 μm. When the thickness of the support is in the above ranges, corrugated shaped creases that occur with heat during the lamination process may be effectively suppressed, and this range is also advantageous from the cost perspective.

Moreover, the conductive layer described in JP-A No. 11-149008 may also be provided on the above support as required.

Thermoplastic Resin Layer

Moreover, it is preferable to provide an alkali soluble thermoplastic resin layer between the support and the photosensitive light-blocking layer, or between the support and an intermediate layer.

Such a thermoplastic resin layer functions as a cushioning material, so that underlying surface irregularities (including irregularities due to images or the like which have already been formed) may be absorbed, the thermoplastic resin layer therefore preferably has the property of being able to change shape according to any irregularities.

The resin contained in such an alkali soluble thermoplastic resin layer is preferably at least one selected from the group consisting of a saponificated copolymer of ethylene and an acrylic acid ester, a saponificated copolymer of styrene and a (meth)acrylate ester, a saponificated copolymer of vinyltoluene and a (meth)acrylate ester, and a saponificated (meth)acrylate ester copolymer of a poly (meth)acrylate ester and butyl (meth)acrylate with vinyl acetate and the like. In addition, alkali aqueous solution soluble resins from among the organic polymers described in “Plastic Performance Manual” (edited by the Japan Plastics Industry Federation and All Japan Plastics Molding Industry Association, published by Kogyo Chosakai Publishing, Oct. 25, 1968) may be used. Moreover, among these thermoplastic resins those that have a softening temperature of 80° C. or below are preferable. It should be noted that in this application specification, “(meth)acrylic acid” has the collective meaning of acrylic acid and of methacrylic acid, and this also applied to modified compounds thereof.

Among the above resins, those having a weight average molecular weight in the range of 50 000 to 500 000 (Tg=0 to 140° C.) are preferably used for the resin contained in the alkali soluble thermoplastic resin layer, and those having a weight average molecular weight in the range of 60 000 to 200 000 (Tg=30 to 110° C.) are even more preferably used. Examples of these resins include alkali aqueous solution soluble resins described in JP-B No. 54-34327, JP-B No. 55-38961, JP-B No. 58-12577, JP-B No. 54-25957, JP-A No. 61-134756, Japanese Patent Publication No. 59-44615, JP-A No. 54-92723, JP-A No. 54-99418, JP-A No. 54-137085, JP-A No. 57-20732, JP-A No. 58-93046, JP-A No. 59-97135, JP-A No. 60-159743, JP-A No. 60-247638, JP-A No. 60-208748, JP-A No. 60-214354, JP-A No. 60-230135, JP-A No. 60-258539, JP-A No. 61-169829, JP-A No. 61-213213, JP-A No. 63-147159, JP-A No. 63-213837, JP-A No. 63-266448, JP-A No. 64-55551, JP-A No. 64-55550, JP-A No. 2-191955, JP-A No. 2-199403, JP-A No. 2-199404, JP-A No. 2-208602, and the Japanese Patent Application No. 4-39653. Particularly preferable examples include the methacrylic acid/2-ethylhexyl acrylate/benzyl methacrylate/methyl methacrylate copolymer described in the specification of JP-A No. 63-147159.

Moreover, among the above-described various resins, those having a weight average molecular weight in the range of from 3000 to 30 000 (Tg=30 to 170° C.) can be preferably used, and those having a weight average molecular weight in the range of from 4000 to 20 000 (Tg=60 to 140° C.) can be more preferably used. Preferable examples thereof may be selected from those described in the above patent specifications, while particularly preferable examples thereof include the styrene/(meth)acrylic acid copolymers described in the publications JP-B No. 55-38961 and JP-A No. 5-241340.

Various plasticizers, various polymers, supercooling materials, adhesion improving agents, surfactants, and/or release agents may also be added to the thermoplastic resin layer in order to adjust the adhesive strength between the thermoplastic resin layer and the support. Examples of preferable plasticizers include: polypropylene glycol, polyethylene glycol, dioctyl phthalate, diheptylphthalate, dibutylphthalate, tricresyl phosphate, cresyl diphenyl phosphate, biphenyl diphenyl phosphate, polyethylene glycol mono(meth)acrylate, polyethylene glycol di(meth)acrylate, polypropylene glycol mono (meth)acrylate, polypropylene glycol di(meth)acrylate, an addition reaction product of epoxy resin and polyethylene glycol mono (meth)acrylate, an addition reaction product of an organic diisocyanate and polyethylene glycol mono (meth)acrylate, an addition reaction product of an organic diisocyanate and polypropylene glycol mono(meth)acrylate, and a condensation reaction product of bisphenol A and polyethylene glycol mono (meth)acrylate. The amount of the plasticizer in the thermoplastic resin layer is generally 200 weight % or less, and is preferably from 20 to 100 weight %, with respect to the amount of the thermoplastic resin in the thermoplastic resin layer. Moreover, the thickness of the alkali soluble thermoplastic resin layer is preferably 6 μm or above. When the thickness of the thermoplastic resin layer is 6 μm or above, then the irregularities of the underlying surface may be completely absorbed. Moreover, from the perspective of developing properties and manufacturability, the maximum thickness of an alkali soluble thermoplastic resin layer is usually about 100 μm or less, and preferably is 50 μm or less.

In the invention, there are no particular limitations to the solvent of the coating liquid used when forming the thermoplastic resin layer, as long as the solvent is able to dissolve the resin configuring this layer. Examples of the solvent include methyl ethyl ketone, cyclohexanone, propylene glycol mono-methyl ether acetate, n-propanol, i-propanol and the like.

Intermediate Layer

Intermediate layers may be provided between a temporary support and the photosensitive light-blocking layer in the photosensitive transfer material of the invention.

There are no particular limitations to the resin which configures the intermediate layer other than being an alkali soluble resin. Examples of the resins include polyvinyl alcohol resins, polyvinyl pyrrolidone resins, cellulose resins, acrylamide resins, polyethylene oxide resin, gelatins, vinyl ether resins, polyamide resins, and copolymers thereof. Moreover, resins which are copolymers of resins which are not usually alkali soluble, like polyester, with monomers which have a carboxyl group or a sulfonic acid group may be used.

Polyvinyl alcohol is preferable among the above. The saponification degree of such a polyvinyl alcohol is preferably 80% or greater, and more preferably from 83% to 98%.

A mixture of two or more kinds of resin is preferably used as the resin to configure the intermediate layer. A mixture of polyvinyl alcohol and polyvinyl pyrrolidone is preferably used as the resin which configures the intermediate layer. The weight ratio of the polyvinyl pyrrolidone/the polyvinyl alcohol is preferably in the range of from 1/99 to 75/25, and more preferably in the range of from 10/90 to 50/50. When the weight ratio is within such limits, the surface shape of the intermediate layer is good and the adhesiveness with the photosensitive light-blocking layer coated thereon is also good, and in addition, a reduction in the oxygen blocking properties to cause a reduction in sensitivity may be prevented.

Additives such as a surfactant may be added to the intermediate layer as required.

The thickness of the above intermediate layer is preferably in the range of from 0.1 μm to 5 μm, and more preferably in the range of from 0.5 μm to 3 μm. When the intermediate layer thickness is in the above range, an increase in the intermediate layer removing time during development may be prevented without a reduction in the oxygen blocking properties thereof.

There are no particular restrictions to the intermediate layer coating solvent, as long as the resin dissolves therein, while water is preferable. A mixed solvent of a water miscibile organic solvent in water is also preferable. Preferable Examples of the solvent include water, a mixed solvent of water/methanol at 90/10, a mixed solvent of water/methanol at 70/30, a mixed solvent of water/methanol at 55/45, a mixed solvent of water/ethanol at 70/30, a mixed solvent of water/1-propanol at 70/30, a mixed solvent of water/acetone at 90/10, and a mixed solvent of water/methyl ethyl ketone at 95/5 (these ratios represent weight ratios).

Production of Photosensitive Transfer Material

The photosensitive transfer material of the invention may be formed by coating a solution of the photosensitive coloring composition for light-blocking image production of the invention on a support using, for example, a coating machine such as a spinner, a foiler, a roller coater, a curtain coater, a knife coater, a wire bar coater, or an extruder, and then drying the coating. When a layer of an alkali soluble thermoplastic resin is provided it can be formed in a similar manner.

Since the photosensitive transfer material of the invention is prepared with the photosensitive light-blocking layer using the photosensitive coloring composition for light-blocking image production of the invention, a light-blocking layer with high optical density in a thin film may be produced.

Light-Blocking Image Manufacturing Method

The light-blocking image of the invention is produced by patterning a light-blocking layer formed using the coloring composition or the photosensitive transfer material. The film thickness of the light-blocking layer is usually in the range of about 0.2 μm to 2.0 μm, and is preferably 0.9 μm or less. Since the light-blocking layer of the invention is one in which metal particles and pigment particles are dispersed, sufficient optical density (3.5 or greater) may be demonstrated by a thin film such as the above.

There are no particular limitations to the method for producing a light-blocking image (patterning) using the coloring composition for light-blocking image production of the invention. Examples of the pattern forming methods of black matrixes are given below.

In a first method, first, the coloring composition for light-blocking image production of the invention that includes the shape-anisotropic metal particles is photosensitive is coated on a substrate to form a photosensitive light-blocking layer containing the shape-anisotropic metal particles. Then, by removing the portions of the light-blocking layer other than those of a pattern by carrying out light exposure and development, pattern forming is performed and a light-blocking image is obtained. Moreover, a protective layer may be formed by forming a layer, configured as per the intermediate layer, on the photosensitive light-blocking layer. When the protective layer is formed, the coating of the protective layer-forming liquid is preferably carried out with a spin coating method.

In a second method, first, a coloring composition for light-blocking image production of the invention that includes the shape-anisotropic metal particles and is non-photosensitive is coated on a substrate to form a light-blocking layer containing shape-anisotropic metal particles. Then, a resist layer is formed on the light-blocking layer by coating a photosensitive resist liquid thereon. Subsequently, after forming a pattern in the resist layer by carrying out light exposure and development of the resist layer with light-exposure, non-pattern portions of the light-blocking layer are dissolved according to the pattern so as to form the pattern in the light-blocking layer. Finally the resist layer is removed and a light-blocking image is produced.

In a third method, a coating layer is formed on a substrate in advance at portions other than those of a pattern. A coloring composition for light-blocking image production of the invention that includes the shape-anisotropic metal particles and is non-photosensitive is coated on the prior-formed coating layer so as to form a light-blocking layer which contains the particles. Subsequently, the coating layer formed first is removed with the portions of the light-blocking layer thereon, and a light-blocking image is produced.

In one example of the manufacturing method of a light-blocking image using the photosensitive transfer material, the photosensitive transfer material is layered by being disposed on a light transmitting substrate so that the photosensitive light-blocking layer formed of the photosensitive transfer material is in contact therewith. Next a support is separated from the layered body of the photosensitive transfer material and the light transmitting substrate, then after exposing the photosensitive light-blocking layer through a photomask for light-blocking images, and the photosensitive light-blocking layer is developed so as to form a light-blocking image.

The manufacturing method for a light-blocking image does not require a complicated process to be performed, and is low cost.

Auxiliary Layer

The auxiliary layer in the invention is a layer which has one, or one or more, of the functions described below, and it is preferably provided adjacent to the light-blocking image layer from a standpoint of impact resistance, chemical resistance, and solvent resistance.

1. A layer formed at the interface between a substrate and a resin layer (light absorption layer) of the invention in order to increase the adhesive force therebetween.

2. A layer provided between a substrate and the resin layer of the invention, or between a resin layer of the invention and another resin layer of the invention, in order to prevent reflection at the interface.

3. A layer provided at an interface between a light reflecting layer and a light absorption layer in order to increase the adhesive force therebetween.

4. A layer provided above a resin layer of the invention for protection.

5. A layer provided for patterning a resin layer in the invention by a photolithographic method.

Specific examples of a layered structure using an auxiliary layer in the invention include, from the substrate side: light-blocking image layer/auxiliary layer; and auxiliary layer/light-blocking image layer/auxiliary layer, while there are no particular limitation to the layer configurations.

Photosensitive Resin Composition for Auxiliary Layers

In addition to the above-described components of the photosensitive resin composition, the photosensitive resin composition for auxiliary layers may further have black or non-black pigments, black or non-black dyes, polymerization inhibitors (suppressor), other surfactants, or the like as required.

When pigments are used, it is preferable that the pigments are dispersed uniformly in the photosensitive coloring resin composition, and therefor, it is preferable that the particle size thereof is 0.1 μm or less, with 0.08 μm or less being particularly preferable.

Examples of black and non-black pigments and dyes include: Victoria Pure Blue BO (CI-42595), Auramine (CI-41000), Fat Black HB (CI-26150), Monolight Yellow GT (CI Pigment Yellow 12), Permanent Yellow GR (CI Pigment Yellow 17), Permanent Yellow HR (CI Pigment Yellow 83), Permanent Camine FBB (CI Pigment Red 146), Hostaperm Red ESB (CI Pigment Violet 19), Permanent Ruby FBH (CI Pigment Red 11), Fastel Pink B Supra (CI Pigment Red 81), Monastral Fast Blue (CI Pigment Blue 15), Monolight Fast Black B (CI Pigment Black 1), and carbon, CI Pigment Red 97, CI Pigment Red 122, CI Pigment Red 149, CI Pigment Red 168, CI Pigment Red 177, CI Pigment Red 180, CI Pigment Red 192, CI Pigment Red 215, CI Pigment Green 7, CI Pigment Blue 15:1, CI Pigment Blue 15:4, CI Pigment Blue 22, CI Pigment Blue 60, CI Pigment Blue 64, CI Pigment Violet 23, CI Pigment Blue 15:6, C.I. Pigment Yellow 139, CI Pigment Red 254, CI Pigment Green 36, C.I. Pigment Yellow 138, and the like.

By using such a photosensitive resin composition obtained in this manner as a coating liquid, and by coating a substrate or temporary support therewith and then drying, a photosensitive resin layer containing an anti-reflection layer can be formed, and a light-blocking image of the invention may be formed through subsequent processing.

Color Filter

The color filter of the invention is formed from coloring layers on a light transmitting substrate, with two or more pixel groups which display different colors from each other. The pixels configuring the pixel groups are each configured with pixels separated from each other by a black matrix, and the black matrix is produced using the coloring composition for light-blocking image production or the photosensitive transfer material of the invention. Two, three, four or more of the pixel groups may be present. For example, in the case where there is three pixel groups, three hues of red (R), green (G) and blue (B) may be used. Such three red, green and blue pixel groups are preferably disposed so as to be arranged in a mosaic shape, a triangular shape, or the like, and when there are four or more pixel groups these may be disposed in any arrangement.

Examples of the light transmitting substrate include conventionally-known glass plates such as soda glass plate which has a silicate coating film on the surface thereof, low thermal expansion glass plate, non-alkali glass plate, and quartz glass plate, or plastic films. In order to produce the color filter, after forming two or more pixel groups on the light transmitting substrate with a conventional method, a black matrix may be formed as described above, or a black matrix may be formed first, and two or more pixel groups may be formed thereafter.

The color filter of the invention is provided with the above-described black matrix, and therefore has high display contrast and excellent flatness characteristics.

Liquid Crystal Display Element

The coloring composition for light-blocking image production of the invention can also be used appropriately for a liquid crystal display element. An example of the liquid crystal display element is one equipped with a color filter, a liquid crystal layer and a liquid crystal driving unit (examples thereof including both simple matrix driving method and active matrix driving method units) between a pair of substrates, at least one of which is light transmitting. The color filter may use a color filter which has plural pixel groups, like those described above, and each pixel configuring the pixel groups are separated from the other pixels by the black matrix of the invention. Since the color filter has high flatness characteristics, cell gap unevenness does not occur between the color filter and the substrate, and display defects, such as color unevenness, are not generated in a liquid crystal display element equipped with the color filter.

In another mode of the liquid crystal display element, the liquid crystal display element has at least a color filter, a liquid crystal layer and a liquid crystal driving unit between a pair of substrates, at least one of which is light transmitting, the liquid crystal driving unit having active elements (for example, TFTs) and a black matrix being formed between each of the active elements, the black matrix being produced using the coloring composition for light-blocking image production or photosensitive transfer material of the invention.

Examples of liquid crystals which may be used for the liquid crystal display element include: nematic liquid crystals, cholesteric liquid crystals, smectic liquid crystals, and strongly dielectric liquid crystals.

Light-Blocking Image-Applied Substrate

The light-blocking image-applied substrate of the invention can be produced by patterning, on a light transmitting substrate, a light-blocking layer formed from the coloring composition for light-blocking image production as described above.

The light-blocking image-applied substrate may also be used for production of a color filter.

The film thickness of the light-blocking image on the light-blocking image-applied substrate (black matrix substrate) is preferably from 0.2 μm to 2.0 μm, and is particularly preferably from 0.2 μm to 0.9 μm. The light-blocking layer in the black matrix substrate is a light-blocking layer with shape-anisotropic metal particles dispersed therein, it therefore has sufficient optical density even in a thin film as described above.

The light-blocking image-applied substrate of the invention may be used, without particular limitation, in applications such as televisions, personal computers, LCD projectors, game consoles, portable devices such as cellular phones, digital cameras, or car navigation devices.

Liquid Crystal Display Element and Liquid Crystal Display

The liquid crystal display element of the invention is configured using the substrate with a light-blocking film of the invention. Since the liquid crystal display element is formed from a light-blocking film which uses a light-blocking film-applied substrate of the invention, or, to be precise, since it is formed from the particle containing composition, the ink for display device colored film formation, or the light-blocking material of the invention, there is little change to color tint with exposure to high temperature environments, hue is good with high optical density, display image contrast is high, and good quality image display is possible.

There are no particular limitations to the configuration of the liquid crystal display element, as long as it is a liquid crystal display element provided with a substrate with the light-blocking film of the invention, and the configuration may be made using additional components of known liquid crystal display elements. For example, the configuration may have a color filter substrate, a light transmitting substrate placed opposite to the color filter substrate, a liquid crystal layer provided between these substrates, and a liquid crystal driving unit (examples thereof including simple matrix driving method driven-units and active matrix driving method unit driven-units) which drives the liquid crystals of the liquid crystal layer, wherein the color filter of the invention is used as the color filter substrate.

The liquid crystal display of the invention is configured using the liquid crystal display element of the invention. Since the liquid crystal display is configured using the liquid crystal display element of the invention, or to be precise since it is configured using the light-blocking film-applied substrate of the invention (with the particle containing composition, ink for display device colored film formation, or light-blocking material of the invention), there is little change to color tint with exposure to high temperature environments, hue is good with high optical density, display image contrast is high, and good quality image display is possible.

There are no particular limitations to the configuration of the liquid crystal display device, as long as it is a liquid crystal display device provided with the liquid crystal display element of the invention, and configuration may be made using additional components of known liquid crystal display devices.

With regard to liquid crystal displays using color TFT method, there are examples described in “Color TFT Liquid Crystal Displays” (published by KYORITSU SHUPPAN Co., Ltd.—1996).

The light-blocking image of the invention may be applied to liquid crystal displays formed from known components. Examples of the components are described, for example, in “94 Market of Peripheral Materials and Chemicals for Liquid Crystal Displays” (by Kentaro SHIMA, published by CMC Co., Ltd. in 1994) and “2003 Liquid Crystal Related Market and Future Outlook (Second Volume) (by Ryokichi OMOTE, published by Fuji Chimera Research Institute—2003), and types of LCD include STN, TN, VA, IPS, OCS, R-OCB, and the like.

The invention will be explained below in more specific detail with reference to Examples thereof, while the invention is not limited to these Examples.

### Example 1

### Coloring Composition

### Synthesis of Polymer S-1

1.22 parts of pentaerythritol tetrakis (3-mercaptopropionate) (PEMP) (made by Sakai Chemical Industry Co., Ltd.), and 30.0 parts of terminal methacryloylated polymethylmethacrylate (trade name: AA-6, made by Toagosei Co., Ltd.) were dissolved in 46.8 parts of methyl ethyl ketone, and heated to 80° C. under a nitrogen gas stream. 0.03 parts of 2,2′-azo bis(2,4-dimethylvaleronitrile) (trade name: V-65, made by Wako Pure Chemical Industries, Ltd.) was added thereto, and heated at 80° C. under a nitrogen gas stream for a further 2 hours. After cooling to room temperature, a 20% solution of the polymer S-1 shown below (weight average molecular weight: 18,000; polymer dispersant according to the invention) was obtained by adding 78.1 parts of methyl ethyl ketone.

### Polymer S-1: (1/2) Adduct of

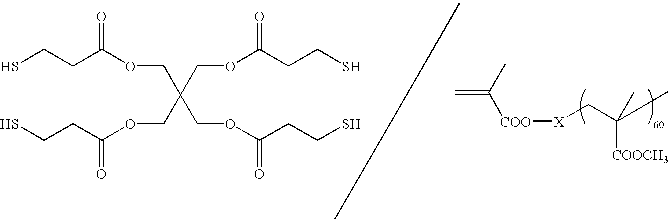

As a raw material silver compound solution, 1.8 g of silver acetate and 0.28 g solids content by weight of the polymer S-1 were added to 45 ml of acetone in a reaction vessel, and mixed. 7.5 ml of ethanolamine was further added and mixed.

22.5 ml of hydroxyl acetone was then added, and a silver particle-containing liquid displaying a vivid and concentrated green was obtained. Water was added to the colloidal solution obtained here, and then, after forming aggregates, carrying out vacuum filtration and repeated water washing, a silver colloid paste was obtained. The solids content by weight was adjusted to 8 weight % using methyl ethyl ketone (SP value: 19). It was confirmed by observation under an electron microscope that these silver particles were particles of two or more particles of particle size 10 nm to 20 nm connected together. The short wavelength side absorption-maximum wavelength and the long wavelength side absorption-maximum wavelength of the silver colloid solution, and the silver solids concentration (86.6 weight %) are shown in Table 1. The silver solids concentration is that derived in the manner described above.

### Examples 2 to 6

### Example of Synthesis of Polymer. S-2

0.81 parts of pentaerythritol tetrakis (3-mercaptopropionate) (PEMP) (made by Sakai Chemical Industry Co., Ltd.), and 30.0 parts of terminal methacryloylated polymethylmethacrylate (trade name: AA-6, made by Toagosei Co., Ltd.) were dissolved in 46.2 parts of methyl ethyl ketone, and heated to 80° C. under a nitrogen gas stream. 0.03 parts of 2,2′-azo bis(2,4-dimethylvaleronitrile) (trade name: V-65, made by Wako Pure Chemical Industries, Ltd.) was added thereto, and heated at 80° C. under a nitrogen gas stream for a further 2 hours. After cooling to room temperature, a 20% solution of the polymer S-2 shown below (weight average molecular weight 21,000; polymer dispersant according to the invention) was obtained by adding 77.0 parts of methyl ethyl ketone.

### Polymer S-2: (1/3) Adduct of

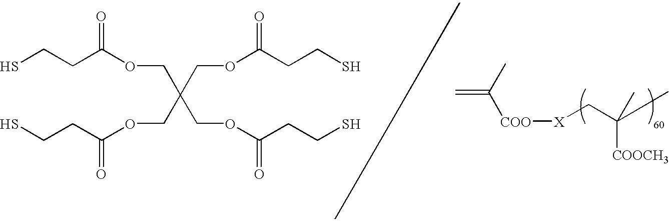

Silver particle-containing liquids of Examples 2 to 6 were obtained in a similar manner to the silver particle-containing liquid of Example 1, except that the blending quantities of raw materials, and the reaction temperatures were changed respectively as shown in Table 1. Measurements of the average particle size, the number of particles connected, the short wavelength side absorption-maximum wavelength and the long wavelength side absorption-maximum wavelength, and the silver solids concentration were each carried out in a similar manner to in Example 1, and the results thereof are shown in Table 1.

### Comparative Example 1

The silver particle-containing liquid of Comparative Example 1 was obtained in a similar manner to Example 1, except that the blending quantity of raw materials and the reaction temperature were changed as shown in Table 1, and a commercial wetting dispersant (trade name: DISPERBYK®161 (made by BYK Co., Ltd.) was used as the polymer dispersant. For the Comparative Example 1, measurements of the average particle size, the number of particles connected, the short wavelength side absorption-maximum wavelength and the long wavelength side absorption-maximum wavelength, and the silver solids concentration were each carried out in a similar manner to in Example 1, and the results thereof are shown in Table 1.

TABLE 1

| | | | | Amount of | | | | Short | | |
|---|---|---|---|---|---|---|---|---|---|---|
| | | | | Polymer | | | | wave-length | Long | |
| | Silver | | | Dispersant | Ethanol | Hydroxyl | | side absorption. | wave-length | Silver solids |
| | Acetate | Acetone | Polymer | (Solid content | amine | acetone | Temp. | maximum. | side absorption. | concentration |
| | (g) | (ml) | Dispersant | amount) (g) | (ml) | (ml) | (° C.) | (nm) | maximum. (nm) | (weight %) |
| Example 1 | 1.8 | 45 | S-1 | 0.28 | 7.5 | 22.5 | 25 | 395 | 625 | 86.6 |
| Example 2 | 2 | 40 | S-2 | 0.16 | 4 | 19 | 25 | 400 | 690 | 89.9 |
| Example 3 | 2 | 38 | S-1 | 0.16 | 6.5 | 19 | 25 | 390 | 610 | 85.7 |
| Example 4 | 2 | 53 | S-1 | 0.16 | 4 | 6 | 25 | 390 | 580 | 88.4 |
| Example 5 | 0.78 | 18.5 | S-2 | 0.04 | 1.5 | 5 | 25 | 395 | 665 | 90.6 |
| Example 6 | 1.8 | 45 | S-1 | 0.28 | 7.5 | 22.5 | 50 | 395 | 650 | 87.1 |
| Comparative | 1.8 | 53 | DISPERBYK | 0.7 | 4 | 6 | 25 | 400 | None | 65 |
| Example 1 | | | 161 | | | | | | | |

### Example 7

### Synthesis of Polymer S-3

6.58 parts of pentaerythritol tetrakis (3-mercaptopropionate) (PEMP) (made by Sakai Chemical Industry Co., Ltd.), and 30.0 parts of methoxy polyethylene glycol #1000 methacrylate (trade name: NK ESTER M-230G, made by Shin-nakamura Chemical Co., Ltd.) were dissolved in 54.9 parts of methyl ethyl ketone, and heated to 80° C. under a nitrogen gas stream. 0.06 parts of 2,2′-azo bis(2,4-dimethylvaleronitrile) (trade name: V-65, made by Wako Pure Chemical Industries, Ltd.) was added thereto, and heated at 80° C. under a nitrogen gas stream for a further 2 hours. After cooling to room temperature, a 20% solution of the polymer S-3 shown below (weight average molecular weight 2,200; polymer dispersant according to the invention) was obtained by adding 91.5 parts of methyl ethyl ketone.

### Polymer S-3: (1/2) Adduct of

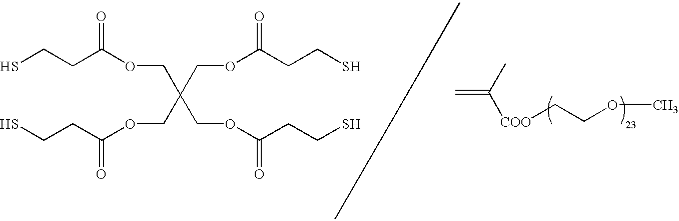

Production of Photosensitive Material

### Preparation of Connected Gold Particles Dispersion Liquid

A solution of a mixture of 150 g of 1N sodium hydroxide aqueous solution and 3,000 g of distilled water was prepared. To this solution a 3.5 g of the polymer S-3 was added and stirred until it completely dissolved. 3.6 g of sodium borohydride was further added, and stirred until dissolved. The resultant is named as a solution C.

A solution was prepared by mixing 74.8 g of hydrogen tetrachloroaurate (III) tetrahydrate with 189 g of distilled water and stirring for 30 minutes. The resultant is named as a solution D.

Solution C was kept at a liquid temperature of 50° C. and stirred, Liquid D was added thereto, so as to prepare a gold particle dispersion liquid.

The pH of the prepared gold particles dispersion liquid was adjusted to pH 4 by adding nitric acid, and aggregation and precipitation of the gold particles was carried out.

The supernatant liquid of the aggregated gold particle liquid was removed, then left to stand for 1 hour after adding distilled water thereto, stirring with a stirrer and dispersing the aggregated gold particles therein, and the re-aggregated gold nano particles were allowed to precipitate out. The supernatant liquid was removed and aggregated gold particles were obtained. Methyl ethyl ketone was added to the aggregated gold particles that had been obtained by repeating this operation several times so that the gold was 8 weight %, and application with 20 kHz ultrasound for 5 minutes was performed thereto using an ultrasonic homogenizer (trade name: SONIFIER II model, made by Branson Ultrasonics Corporation). Then, 40 kHz ultrasound was applied for 10 minutes using an ultrasonic homogenizer (trade name: Model 2000 bdc-h 40:0.8, made by Branson Ultrasonics Corporation). Between the periods of ultrasonic application, the liquid was cooled using a constant temperature water circulation apparatus (trade name: COOLNICS® CTW400, made by Yamato Scientific Co., Ltd.) so that the sample solution was maintained at 25° C. The gold particles in the sample solution obtained had an arithmetic mean particle size of 45 nm and an arithmetic standard deviation of 34 nm. The gold solids concentration was 87.3 weight %. The gold solids concentration is that derived in the manner described above.

Preparation of Coating Liquid for Photosensitive Light-Blocking Layers

The following compositions were mixed together and a coating liquid for the photosensitive light-blocking layer was prepared.

### Formulation:

| | | |
|---|---|---|
| Gold particles dispersion liquid described above | 100 | g |
| Methyl ethyl ketone | 39 | g |
| Fluorosurfactant | 0.1 | g |
| (trade name: F780F, made by Dainippon | | |
| Ink and Chemicals, Inc.) | | |
| Hydroquinone monomethyl ether | 0.001 | g |
| Benzyl methacrylate/methacrylic acid copolymer | 2.1 | g |
| (mole ratio = 73/27, molecular weight: 30,000) | | |
| Bis [4-[N-[4-(4,6-bis trichloromethyl-s-triazine-2-yl) | 0.1 | g |
| phenyl] carbamoyl] phenyl] sebacate | | |

Preparation of Protective Layer Coating Liquid

The following compositions were mixed together and the protective layer coating liquid was prepared.

| | | |
|---|---|---|
| Polyvinyl alcohol | 3.0 | g |
| (trade name: PVA205, made by Kuraray Co., Ltd.) | | |
| Polyvinyl pyrrolidone | 1.3 | g |
| (trade name: PVP-K30, made by ISP Japan Ltd.) | | |
| Distilled water | 50.7 | g |
| Methyl alcohol | 45.0 | g |

Production of Photosensitive Material

A photosensitive light-blocking layer was formed by coating the coating liquid for photosensitive light-blocking layers on a glass substrate using a spin coater, at an amount such that the dry film thickness thereof became 0.8 μm, and then drying was carried out for 5 minutes at 100° C. Subsequently, the protective layer was formed by coating the protective layer coating liquid thereon with a spin coater, in an amount such that the dry film thickness was 1.5 μm, and then drying was carried out for 5 minutes at 100° C., and the photosensitive material was obtained.

Black Matrix Production

Patterning light-exposure was carried out with a proximity type light-exposure machine (made by Hitachi Electronics Engineering) having an ultrahigh pressure mercury lamp, with a substrate and a mask (quartz light-exposure mask with an image pattern) placed standing vertically, the distance between the light-exposure mask face and the coating face of the protective layer set at 200 μm, and the with light-exposure amount set at 70 mJ/cm². Subsequently, developing was performed (33° C. and 20 seconds) using a processing liquid (trade name: TCD, made by Fuji Photo Film Co., Ltd.), which is an alkali developing solution. A black matrix was obtained with a screen size of 10 inches, number of pixels of 480×640, width of the black matrix of 24 μm, and apertures of the pixel portions at 86 μm×304 μm.

Evaluation

The following evaluations were performed on the obtained black matrix. Results are shown in the following Table 2.

### Measurement of Optical Density

The optical density of the film was measured by the following method.

First, an ultrahigh pressure mercury lamp was used to carry out exposure at 500 mJ/cm² to the photosensitive light-blocking layer coated on the glass substrate before black-matrix production, exposing from the coating face side. The optical density (O.D.) thereof was then measured using a Macbeth densiometer (trade name: TD-904, made by Macbeth Co., Ltd.). Separately, the optical density (OD0) of a glass substrate was measured in a similar manner, and the value of OD0 was deducted from the above O.D., and this value was taken as the optical density of the film.

Production of Liquid Crystal Display

A liquid crystal display was produced using the substrate formed with the black matrix obtained as above, using the method described in Example 1 of JP-A No. 11-242243, paragraphs [0079] to [0082], and it was confirmed that the liquid crystal display performs error free display.

Evaluation

The following evaluations were performed on the liquid crystal display obtained. Results are shown in the following Table 1.

### Measurement of Unevenness

The existence or not of unevenness when a gray test signal was input to the liquid crystal display was determined by observation with the naked eye and with a magnifying lens. Evaluation was assigned as A when there was no unevenness observed at all, B when slight unevenness was observed, and X when noticeable unevenness was observed.

### Example 8

### Preparation of Connected Silver Particle Dispersion Liquid

A black matrix and a liquid crystal display of Example 8 were produced and evaluations were carried out in a similar manner to those of Example 7, except that a silver particle dispersion liquid produced in a similar manner to Example 2 was used instead of the gold particles dispersion liquid of Example 7. Results are shown in the following Table 2.

### Example 9

### Preparation of Connected Silver Particle Dispersion Liquid

As a raw material metal compound solution, 17 g of silver acetate, 3.0 g the polymer S-3 and 60 g of ethanolamine were added to 380 g of acetone in a reaction vessel, and these were stirred until the silver acetate dissolved completely.

160 g of hydroxyl acetone was added to this, and a silver particle-containing liquid which has absorption in all the visible region with particular high absorptions at 400 nm and at 710 nm was obtained thereby. After carrying out repeated water washing several times to the obtained colloidal solution, the resultant was dissolved in methyl ethyl ketone and adjusted so that the solids content was 8 weight %. By observation under an electron microscope, it was confirmed that two or more silver particles with a mean particle sizes of 10 nm were connected together. The silver solids concentration was 90.1 weight %. The silver solids concentration being that derived in the manner described above.

A black matrix and a liquid crystal display of Example 9 were produced and evaluations were carried out in a similar manner to those of Example 7, except that the above silver particle dispersion liquid was used instead of the gold particles dispersion liquid of Example 7. Results are shown in the following Table 2.

### Example 10

Connected silver particles were produced in a similar manner to in Example 8, and 0.95 g of a polymer (a copolymer of vinyl pyrrolidone/vinyl acetate at 60/40 (weight ratio), molecular weight: 5,000) was added to 200 g of the acetone dispersion of the silver particles, and this was stirred for 30 minutes.

Subsequently, a sodium sulfide aqueous solution of concentration 7.2 weight % was added thereto, while stirring, to give a sulfurization rate of metallic components therein of 10%.

It should be noted that by “sulfurization rate” is meant the proportion of the metal particles that have been transformed into the sulfide thereof relative to total metallic components, with a 0% sulfurization rate indicating a state in which no transformation into the sulfide has occurred at all, and a 100% sulfurization rate indicating a state where all the particles have been completely transformed into the sulfide. The liquid temperature when the sodium sulfide aqueous solution was added was 23° C.

Stirring was continued for 30 minutes after the sodium sulfide aqueous solution addition.

Silver core-shell particles, having a shell of silver sulfide, were formed by the above process.

The weight ratio of the shell in the particles was 0.11. This weight ratio was calculated from the number of moles of silver and of sulfur in the particles. Both these mole numbers are derived by fluorescent X-ray analysis using a fluorescent X-ray analysis device (trade name: TYPE 3370E, made by Rigaku Denki KK) on a sample in which the particle dispersion liquid is spin coated onto a polyethylene terephthalate support. If the number of moles of sulfur and silver are designated as ms and mA, respectively, the number of moles of Ag₂S of the shell is ms, and the number of moles of Ag in the core is mA-2 ms.

Therefore, the weight ratio of the shell to the core is:

(ms/247.8): (mA-2 ms/107.9)

After water washing several times the silver/silver sulfide core-shell particle-containing liquid produced as above, aggregated silver/silver sulfide core-shell particles were taken out by vacuum filtration, and adjusted so as to be 8 weight % using methyl ethyl ketone. The black matrix and liquid crystal display of Example 10 were produced and evaluations were performed in a similar manner to Example 7, except that this silver/silver sulfide core-shell particle-containing liquid was used instead of the gold particles of Example 7. Results are shown in the following Table 2.

### Example 11

The black matrix and liquid crystal display of Example 11 were produced and evaluations were performed in a similar manner to Example 7, except that when preparing the coating liquid for photosensitive light-blocking layer, a silver particle dispersion that was prepared from the silver particles described in Example 8 and from carbon black (trade name: CFP-FF-949K, made by FUJIFILM Electronic Materials Co., Ltd.) was used in place of the gold particle dispersion liquid of Example 1, and an addition amount of the carbon black was adjusted so that the ratio of the amount of the carbon black to that of the silver particles: carbon black becomes 95:5 (weight ratio). Results are shown in the following Table 2.

### Comparative Example 2

41 g of hydrogen tetrachloroaurate (III) tetrahydrate, 10 g of a commercial wetting dispersant (trade name: DISPERBYK®190, made by BYK Co., Ltd.) and 80 g of 1N NaOH aqueous solution was mixed with 380 g of pure water. 3 g of sodium borohydride was added to this solution and stirred for 30 minutes, and gold particles having a high absorption at 500 nm were obtained. After concentrating the obtained colloidal solution by ultrafiltration, the resultant was dissolved in ethanol and adjusted so that the solids content by weight was 8 weight %. The gold solids concentration of the total solids weight was 70.5 weight %. This gold particle dispersion liquid was subjected to 20 kHz ultrasound for 5 minutes using an ultrasonic homogenizer (trade name: SONIFIER II model, made by Branson Ultrasonics Corporation). Application of 40 kHz ultrasound was then carried out for 10 minutes with an ultrasonic homogenizer (trade name: Model 2000 bdc-h 40:0.8, made by Branson Ultrasonics Corporation). Between the two periods of ultrasonic application, the dispersion liquid was cooled with a constant temperature water circulation apparatus (trade name: COOLNICS® CTW400, made by Yamato Scientific Co., Ltd.) so that the sample solution was maintained at 25° C. The gold particles in the sample solution obtained had a 42 nm arithmetic mean particle size and a 56 nm arithmetic standard deviation.

A black matrix and liquid a crystal display were produced and evaluations were performed in a similar manner to in Example 7 using the gold particles produced above, except that the coating liquid composition was changed as shown below. Results are shown in the following Table 2.

| | | |
|---|---|---|
| Gold particles dispersion liquid described above | 100 | g |
| 1-propanol | 39 | g |
| Fluorosurfactant | 0.1 | g |
| (trade name: F780F, made by Dainippon Ink | | |
| and Chemicals, Inc.) | | |
| Hydroquinone monomethyl ether | 0.001 | g |
| Benzyl methacrylate/methacrylic acid copolymer | 2.1 | g |
| (mole ratio: 73/27, molecular weight: 30,000) | | |
| Bis [4-[N-[4-(4,6-bis trichloromethyl-s-triazine-2-yl) | 0.1 | g |
| phenyl] carbamoyl] phenyl] sebacate | | |

Preparation of Protective Layer Coating Liquid

The following compositions were mixed so as to prepare a protective layer coating liquid.

| | | |
|---|---|---|
| Polyvinyl alcohol | 3.0 | g |
| (trade name: PVA205, made by Kuraray Co., Ltd.) | | |
| Polyvinyl pyrrolidone | 1.3 | g |
| (trade name: PVP-K30, made by ISP Japan Ltd.) | | |
| Distilled water | 50.7 | g |
| Methyl alcohol | 45.0 | g |

### Comparative Example 3

A raw material metal compound solution was prepared by adding 6 g of silver acetate to 180 g acetone in a reaction vessel and stirring. 3 g of a commercial wetting dispersant (trade name: DISPERBYK®161, made by BYK Co., Ltd.) and 25 g of ethanolamine were added thereto and stirred until the silver acetate dissolved completely. 50 g of hydroxyl acetone was added to the obtained so as to obtain a silver particle-containing liquid displaying a yellow color. These particles had a high absorption at 400 nm, and an arithmetic mean particle size of 51 nm and arithmetic standard deviation of 63 nm.

Observation under an electron microscope showed that these silver particles were spherically shaped particles with a mean particle size of 30 nm. The silver particles were water washed several times, dissolved in methyl ethyl ketone, and adjusted so that the solids content was 8 weight %.

The black matrix and liquid crystal display of Comparative Example 3 were produced and evaluations were performed in a similar manner to Example 7, except that the silver particles produced above were used instead of the gold particles of Example 7. Results are shown in the following Table 2.

### Comparative Example 4

73.5 g of tabular silver particles having an average length of 100 nm, an average width of 100 nm and an average thickness of 46 nm, 1.05 g of a commercial wetting dispersant (trade name: DISPERBYK® 161, made by BYK Co., Ltd.), and 110.3 g of methyl ethyl ketone were mixed together, dispersed using an ultrasonic dispersion machine (trade name: ULTRASONIC GENERATOR MODEL US-6000-ccvp, made by Nissei) so as to obtain a tabular silver particle dispersion liquid.

The black matrix and liquid crystal display of Comparative Example 4 were produced and evaluations were performed in a similar manner to Example 7, except that the silver particle dispersion liquid produced above was used instead of the gold particles dispersion liquid of Example 7. Results are shown in the following Table 2.

TABLE 2

| | | | Pigment | | |
|---|---|---|---|---|---|
| | | | combined | Optical | Display |
| | Metal | Form | with | Density | Unevenness |
| Example 7 | Gold | Particles connected | — | 4.1 | ◯ |
| | | together in a chain | | | |
| Example 8 | Silver | Particles connected | — | 4.2 | ◯ |
| | | together in a chain | | | |
| Example 9 | Silver | Particles connected | — | 4.5 | ◯ |
| | | together in a chain | | | |
| Example 10 | Silver/ | Particles connected | — | 4.3 | ◯ |
| | Silver Sulfide | together in a chain | | | |
| Example 11 | Silver | Particles connected | Carbon | 4.1 | ◯ |
| | | together in a chain | Black (5%) | | |
| Comparative | Gold | Spherical | — | 1.2 | ◯ |
| Example 1 | | | | | |
| Comparative | Silver | Spherical | — | 1 | ◯ |
| Example 2 | | | | | |
| Comparative | Silver | Tabular | — | 4 | Δ |
| Example 3 | | | | | |

From Table 2 it can be seen that Examples 7 to 11, that accord to the invention, exhibit high optical densities, and display unevenness was not observed at all. In contrast, in Comparative Examples 2 to 4, results were not obtainable which satisfied both the evaluation of optical density and evaluation of display unevenness.

The whole of the disclosure of Japanese Patent Application 2005-305026 is incorporated by reference herein. All publications, patent applications, and technical standards mentioned in this specification are herein incorporated by reference to the same extent as if each individual publication, patent application, or technical standard was specifically and individually indicated to be incorporated by reference.

### INDUSTRIAL APPLICABILITY

The invention provides a method for producing shape-anisotropic metal particles which enables the manufacture of shape-anisotropic metal particles with high dispersion stability. The invention moreover provides a coloring composition that enables coloring with a high color density even when made into a thin film, and in particular a coloring composition and a photosensitive transfer material capable of producing, at low cost, a light-blocking image of high light-blocking performance and having excellent environmental characteristics. The invention also provides a light-blocking image-applied substrate of high light-blocking performance even when made into a thin film, a color filter, and a liquid crystal display.

1. A method for producing shape-anisotropic metal particles comprising reducing a metal compound in the presence of a polymer dispersant which has a mercapto group within its molecule.

2. The method for producing shape-anisotropic metal particles according to claim 1, wherein the shape-anisotropic metal particles are formed by connecting together a plurality of metal particles, and wherein differences in the combination lengths of the plurality of metal particles cause differences in color tones of the connecting metal particles.

3. The method for producing shape-anisotropic metal particles according to claim 1, wherein the shape-anisotropic metal particles are formed from composite particles formed of a metal compound and a metal.

4. The method for producing shape-anisotropic metal particles according to claim 1, wherein the shape-anisotropic metal particles have absorption maxima in two or more wavelength regions of the wavelength regions of ultraviolet light, visible light, and near-infrared light, and wherein the absorption wavelength is changed by changing a combination length of the metal particles.

5. The method for producing shape-anisotropic metal particles according to claim 1, wherein the polymer dispersant includes at least two or more mercapto groups at a terminus of its molecule chain.

6. A coloring composition obtained by disposing shape-anisotropic metal particles in a solvent having an SP value of 25.8 MPa^{1/2} or less, the shape-anisotropic metal particles being produced by a method comprising reducing a metal compound in the presence of a polymer dispersant which has a mercapto group within its molecule.

7. The coloring composition according to claim 6, wherein the shape-anisotropic metal particles are formed by connecting together a plurality of metal particles, and wherein differences in the combination lengths of the plurality of metal particles cause differences in color tones of the connecting metal particles.

8. The coloring composition according to claim 6, further comprising a pigment.

9. The coloring composition according to claim 8, wherein the pigment comprises at least one pigment selected from the group consisting of carbon black, titanium black, and graphite.

10. A photosensitive transfer material comprising a support and a photosensitive light-blocking layer provided on the support, the coloring composition being obtained by disposing shape-anisotropic metal particles in a solvent having an SP value of 25.8 MPa^{1/2} or less, and the shape-anisotropic metal particles being produced by a method comprising reducing a metal compound in the presence of a polymer dispersant which has a mercapto group within its molecule.

11. The photosensitive transfer material according to claim 10, wherein the shape-anisotropic metal particles are formed by connecting together a plurality of metal particles, and wherein differences in the combination lengths of the plurality of metal particles cause differences in color tones of the connecting metal particles.

12. A light-blocking image-applied substrate comprising a light-blocking image containing a coloring composition, the coloring composition being obtained by disposing shape-anisotropic metal particles in a solvent having an SP value of 25.8 MPa^{1/2} or less, and the shape-anisotropic metal particles being produced by a method comprising reducing a metal compound in the presence of a polymer dispersant which has a mercapto group within its molecule.

13. The light-blocking image-applied substrate according to claim 12, wherein the shape-anisotropic metal particles are formed by connecting together a plurality of metal particles, and wherein differences in the combination lengths of the plurality of metal particles cause differences in color tones of the connecting metal particles.

14. A light-blocking image-applied substrate comprising a light-blocking image produced using a photosensitive transfer material, the photosensitive transfer material comprising a support and a photosensitive light-blocking layer that comprises a coloring composition and that is provided on the support, the coloring composition being obtained by disposing shape-anisotropic metal particles in a solvent having an SP value of 25.8 MPa^{1/2} or less, and the shape-anisotropic metal particles being produced by a method comprising reducing a metal compound in the presence of a polymer dispersant which has a mercapto group within its molecule.

15. The light-blocking image-applied substrate according to claim 14, wherein the shape-anisotropic metal particles are formed by connecting together a plurality of metal particles, and wherein differences in the combination lengths of the plurality of metal particles cause differences in color tones of the connecting metal particles.

16. A color filter comprising a coloring composition, the coloring composition being obtained by disposing shape-anisotropic metal particles in a solvent having an SP value of 25.8 MPa^{1/2} or less, and the shape-anisotropic metal particles being produced by a method comprising reducing a metal compound in the presence of a polymer dispersant which has a mercapto group within its molecule.

17. The color filter according to claim 16, wherein the shape-anisotropic metal particles are formed by connecting together a plurality of metal particles, and wherein differences in the combination lengths of the plurality of metal particles cause differences in color tones of the connecting metal particles.

18. A liquid crystal display device comprising a coloring composition, the coloring composition being obtained by disposing shape-anisotropic metal particles in a solvent having an SP value of 25.8 MPa^{1/2} or less, and the shape-anisotropic metal particles being produced by a method comprising reducing a metal compound in the presence of a polymer dispersant which has a mercapto group within its molecule.

19. The liquid crystal display device according to claim 18, wherein the shape-anisotropic metal particles are formed by connecting together a plurality of metal particles, and wherein differences in the combination lengths of the plurality of metal particles cause differences in color tones of the connecting metal particles.
